(19) United States
(12) Patent Application Publication
(10) Pub. No.: US 2016/0156611 A1
(43) Pub. Date: Jun. 2, 2016

(54) MULTIPARTY SECRET PROTECTION SYSTEM

(71) Applicant: LYNXGUARD LTD., Herzliya (IL)

(72) Inventor: Michael Rozman, Rosh Ha'Ayin (IL)

(21) Appl. No.: 14/782,793

(22) PCT Filed: Apr. 10, 2014
(86) PCT No.: PCT/IB2014/060619

§ 371 Date: Oct. 7, 2015

Related U.S. Application Data
(60) Provisional application No. 61/867,183, filed on Aug. 19, 2013.

(51) Int. Cl. H04L 29/06

(52) U.S. Cl. CPC H04L 63/083; H04L 63/1433; H04L 63/06; H04L 67/42; H04L 63/0428

(57) ABSTRACT

A secret protection method operative on a user's device with a group of servers includes concealing a secret on the user's device with the user's password, the concealing not involving any of the servers, storing the output of the concealing on the device and reconstructing the secret from a newly received password and the stored output in conjunction with a subset of the group of servers, wherein the reconstructing is minimally affected by intermittent network connection problems and attacks that interfere with the communication between the user's device and the subset of servers, The reconstructing includes performing an enhanced PPSS (Password Protected Secret Sharing) reconstruction protocol between the user's device and the subset of servers and receiving the results of throttling performed by each of the subset of servers.

### CROSS REFERENCE TO RELATED APPLICATION

This application claims priority from U.S. Provisional Patent Application 61/867,183, filed Aug. 19, 2013, which application is incorporated herein by reference.

### FIELD OF THE INVENTION

The present invention relates to the protection of personal secrets generally.

### BACKGROUND OF THE INVENTION

Relying on digital signatures for personal authentication (as done in SSL client authentication) is a well-established approach. However, the reliability of digital signatures depends on the assumption that users' private keys are well protected. In reality, private keys are often stored in portable 2-factor authentication devices (such as USB tokens and smartcards) to allow users to carry their means of authentication with them. These devices are password protected. One weakness of this approach is the risk that the private key will get revealed if the device falls into the wrong hands. The attackers would then need to physically attack the device in order to read the sensitive data. Appropriate tamper resistant hardware designs can make this type of attack difficult. However, there is no way to completely eliminate the risk. In order to reduce the risk, private keys are stored in encrypted form where the user's password is required for decryption. But since passwords are relatively short, brute force attack on the password will reveal the private key once its encrypted form is revealed.

A more advanced approach to secure storage of secret data relies on secret sharing. According to this approach, the secret is split into multiple shares and each share is stored at a separate server. The secret can then be reconstructed on a client compu [symbol] reconstruction protocol. Password Protected Secret Sharing (PPSS), as defined in ACM-978-1-4503-0948-Jun. 11, 2010 by Ali Bagherzandi is “a method which allows a user to secret-share her data among n trustees in such a way that (1) the user can retrieve the shared secret upon entering a correct password into a reconstruction protocol, which succeeds as long as at least t+1 uncorrupted trustees are accessible, and (2) the shared data remains secret even if the adversary corrupts t trustees, with the level of protection expected, of password-authentication, i.e. the probability that the adversary learns anything useful about the secret is at most q/|D| where q is the number of reconstruction protocol the adversary manages to trigger and |D| is the size of the password dictionary.” The article then describes a detailed PPSS scheme which is notably efficient and robust. The proposed scheme is also applicable to 2-factor authentication systems, where it is required that the secret can be reconstructed only at a personal computing device (such as a smartphone) that belongs to the user. The article suggests that this property is achieved by splitting the secret into 2n-t shares and assigning n-t shares to the device. In this configuration the device plays the part of n-t trustees during secret reconstruction.

### SUMMARY OF THE PRESENT INVENTION

There is provided, in accordance with a preferred embodiment of the present invention, a secret protection method operative on a user's device with a group of servers. The method includes concealing a secret on the user's device with the user's password, the concealing not involving any of the servers, storing the output of the concealing on the device and reconstructing the secret from a newly received password and the stored output in conjunction with a subset of the group of servers, wherein the reconstructing is minimally affected by intermittent network connection problems and attacks that interfere with the communication between the user's device and the subset of servers. The reconstructing includes performing an enhanced PPSS (Password Protected Secret Sharing) reconstruction protocol between the user's device and the subset of servers and receiving the results of throttling performed by each of the subset of servers.

Moreover, in accordance with a preferred embodiment of the present invention, the concealing includes implementing a PPSS-Init process and encrypting asymmetrically PPSS private states produced by the PPSS-Init process with public keys of the servers.

Further, in accordance with a preferred embodiment of the present invention, the concealing includes generating a plurality of messenger tokens, one per server, each the messenger token including at least: one of the encrypted PPSS private states and throttling data, wherein the generating includes signing at least part of each the messenger token with a client signature key.

Still further, in accordance with a preferred embodiment of the present invention, the reconstructing includes transmitting messages between the user's device and the subset of servers, each message including at least one of: a messenger token and a PPSS message.

Moreover, in accordance with a preferred embodiment of the present [symbol] throttling data includes a proof of success, if the secret was successfully reconstructed since the last time reconstruction occurred, and the messages include a proof of same password, if the same password was used the last time.

Additionally, in accordance with a preferred embodiment of the present invention, the proof of success is embodied in a success counter and a valid client signature.

Further, in accordance with a preferred embodiment of the present invention, the throttling includes each server of the subset of servers checking for the proof of success and proof of repeated password and generating a foul event when neither proof is received, generating a success event when the proof of success is received and not generating a new foul event if the proof of repealed password is received from the device.

Still further, in accordance with a preferred embodiment of the present invention, the throttling includes determining whether to reject or accept a message from a device as a result of the checking and the recent history of the foul and success events.

Moreover, in accordance with a preferred embodiment of the present invention, the concealing includes preserving a last client-side state on the device in a secure manner and the reconstructing includes recovering the last client-side state with a pair of the group of servers when the reconstructing follows a previously aborted reconstruction attempt. The recovering will succeed only if the user has entered again exactly the same password as in the aborted attempt.

Additionally, in accordance with a preferred embodiment of the present invention, the method also includes after a successful reconstruction, generating the proof of success by incrementing a success counter, generating new the messenger tokens at least with the success counter and at least partially signing the messenger tokens with a client signature key.

Moreover, in accordance with a preferred embodiment of the present [symbol] method includes each server of the subset of servers verifying the signature with a client-validation-key associated with the client signature key.

Further, in accordance with a preferred embodiment of the present invention, the method also includes each server of the subset of servers verifying that a received the success counter is greater or equal to a stored the success counter, stored on each server, and updating the stored success counter if the output of the verifying is positive.

There is provided, in accordance with a preferred embodiment of the present invention, a secret reconstruction process operative on a server. The process includes receiving a message from a user's device, the message including at least one of: a PPSS message, an encrypted PPSS private state, a proof of success, if the secret was successfully reconstructed since the last time reconstruction involving the server occurred, and a proof of same password, if the same password was used the last time. The process also includes checking at least the proof of success and proof of same password against a stored client state for the user's device to determine if the reconstruction can proceed, updating the stored client state and if the output of the checking is positive, performing a portion of a reconstruction operation on the PPSS private state and/or PPSS message within the message.

Furthermore, in accordance with a preferred embodiment of the present invention, the client state includes at least a client validation key and a success counter.

Moreover, in accordance with a preferred embodiment of the present invention, the checking includes verifying a signature of the message with the stored client-validation-key.

Still further, in accordance with a preferred embodiment of the present invention, the checking includes checking for the proof of success and proof of repeated password and generating a foul event when neither proof is received, generating a success event when the proof of success is received and not generating a new foul event if the pro [symbol] password is received from the device.

Additionally, in accordance with a preferred embodiment of the present invention, the checking includes checking that the success counter is greater than or equal to the stored success counter, and updating the stored success counter if the output of the verifying is positive

Moreover, in accordance with a preferred embodiment of the present invention, the method also includes receiving a message from a user's device to perform an unlock process and unlocking a locked client-side-state together with one other server.

There is also provided, in accordance with a preferred embodiment of the present invention, a secret protection unit for a user's device operative with a group of servers. The unit includes a secret concealment unit, a storage unit, and a secret reconstruction unit. The secret concealment unit conceals a secret on the user's device with the user's password, without the use of any of the servers. The storage unit stores the output of the secret concealment unit. The secret reconstruction unit reconstructs the secret from a newly received password and the stored output in conjunction with a subset of the group of servers, wherein the secret reconstruction unit is minimally affected by intermittent network connection problems and attacks that interfere with the communication between the user's device and the subset of servers. The secret reconstruction unit includes an enhanced PPSS unit to perform an enhanced PPSS (Password Protected Secret Sharing) reconstruction protocol between the user's device and the subset of servers and a throttling receiver to receive the output from throttling units on each of the subset of servers.

Moreover, in accordance with a preferred embodiment of the present invention, the secret concealment unit includes a PPSS-Init process to implement a PPSS-Init process and an encrypter to asymmetrically encrypt PPSS private stales produced by the PPSS-In [symbol] public keys of the servers.

Furthermore, in accordance with a preferred embodiment of the present invention, the secret concealment unit includes a token generator to generate a plurality of messenger tokens, one per server, each messenger token including at least: one of the encrypted PPSS private states and throttling data, wherein the token generator includes a digital signer to sign at least part of each messenger token with a client signature key.

Still further, in accordance with a preferred embodiment of the present invention, the secret reconstruction unit includes a transmitter to transmit messages between the user's device and the subset of servers, each message including at least one of: a messenger token and a PPSS message.

Additionally, in accordance with a preferred embodiment of the present invention, the throttling unit on each server of the subset of servers includes checkers to check for the proof of success and proof of repeated password and to generate a foul event when neither proof is received, to generate a success event when the proof of success is received and not to generate a new foul event if the proof of repeated password is received from the device.

Moreover, in accordance with a preferred embodiment of the present invention, each throttling unit includes a determiner to determine whether to reject or accept a message from a device as a result of the checking and the recent history of the foul and success events.

Additionally, in accordance with a preferred embodiment of the present invention, the secret concealment unit includes a locking unit to preserve a last client-side state on the device in a secure manner and wherein the secret reconstruction unit includes a locked state recoverer to recover the last client-side state with a pair of the group of servers after a previously aborted reconstruction attempt, and wherein the secret reconstruction unit will succeed [symbol] has entered again exactly the same password as in the aborted attempt.

Moreover, in accordance with a preferred embodiment of the present invention, the secret reconstruction unit also includes a generator to generate the proof of success after a successful reconstruction by incrementing a success counter, to generate new the messenger tokens at least with the success counter and to at least partially sign the messenger tokens with a client signature key.

Further, in accordance with a preferred embodiment of the present invention, each server of the subset of servers includes a verifier to verify the signature with a client-validation-key associated with the client signature key.

Still further, in accordance with a preferred embodiment of the present invention, the verifier also includes a second verifier to verify that a received the success counter is greater or equal to a stored the success counter, stored on each server, and to update the stored success counter if the output of the verifying is positive.

There is also provided, in accordance with a preferred embodiment of the present invention, a secret reconstruction unit on a server. The unit includes a receiver, a checker, an updater and a reconstructer. The receiver receives a message from a user's device, the message including at least one of: a PPSS message, an encrypted PPSS private state, a proof of success, if the secret was successfully reconstructed since the last time reconstruction involving the server occurred, and a proof of same password, if the same password was used the last time. The checker checks at least the proof of success and proof of same password against a stored client state for the user's device to determine if the reconstruction can proceed. The updater updates the stored client state. The reconstructer performs a portion of a reconstruction operation on the PPSS private state and/or PPSS message within the message, i [symbol] the checking is positive.

Moreover, in accordance with a preferred embodiment of the present invention, the checker includes a verifier to verify a signature of the message with the stored client-validation-key.

Furthermore, in accordance with a preferred embodiment of the present invention, the checker includes a second checker to check for the proof of success and proof of repeated password and to generate a foul event when neither proof is received, to generate a success event when the proof of success is received and to not generate a new foul event if the proof of repeated password is received from the device.

Still further, in accordance with a preferred embodiment of the present invention, the checker includes a second checker to check that the success counter is greater than or equal to the stored success counter, and to update the stored success counter if the output of the verifier is positive

Finally, in accordance with a preferred embodiment of the present invention, the receiver includes a second receiver to receive a message from a user's device to perform an unlock process and the reconstructer includes an unlocker to unlock a locked client-side-state together with one other server.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A, 1B and 1C are schematic illustration of a prior art Password Protected Secret Sharing (PPSS) method;

FIG. 2 is a schematic illustration of a secret protection system, constructed and operative in accordance with a preferred embodiment of the present invention;

FIG. 3 is a schematic illustration of a PPSS-Init process performed on a secret, useful in the system of FIG. 2;

FIG. 4 is a schematic illustration of the creation of messenger tokens on a client device, useful in the system of FIG. 2;

FIG. 5 is a schematic illustration of the creation of a client state, useful in the system of FIG. 2;

FIG. 6 is a schematic illustration of the secret reconstruction process performed by the client device with a plurality of secret reconstruction servers, useful in the system of FIG. 2;

FIG. 7 is a schematic illustration of the processing of an MPSP message, useful in the process of FIG. 6;

FIGS. 8, 9, 10A and 10B are schematic illustrations of a lock and an unlock protocol, useful in the system of FIG. 2;

FIG. 11 is a schematic illustration of an exemplary secret concealment process;

FIG. 12 is a schematic illustration of exemplary messages transmitte [symbol] client and the server in an exemplary secret reconstruction process; and

FIGS. 13, 14, 15 and 16 are schematic illustrations of an exemplary lock and unlock protocol.

It will be appreciated that for simplicity and clarity of illustration, elements shown in the FIGS. have not necessarily been drawn to scale. For example, the dimensions of some of the elements may be exaggerated relative to other elements for clarity. Further, where considered appropriate, reference numerals may be repeated among the FIGS. to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that, while Password Protected Secret Sharing (PPSS) as described in the article by Ali Bagherzandi (ACM-978-1-4503-0948-Jun. 11, 2010) may be appropriate for secure storage of personal private data, it has a few notable limitations which need to be addressed before it can be implemented in large scale systems. In particular:

1. The article does not specify how the secret is protected against online dictionary attacks, in which an adversary who controls the user's device triggers the protocol multiple times with different passwords in attempt to find the correct password. The protocol itself provides no indication to servers as for whether the user provided the correct password.

2. The initial procedure of protecting a user's secret requires distributi [symbol] secret shares to all servers. Therefore it cannot be completed unless all n [symbol] servers are accessible.

3. Changing a password requires redistribution of secret shares to all servers. Therefore ail n servers must be accessible before a user can change the password.

4. Since users' secret shares are regularly stored at servers, a robust data storage system is required, to allow recovery in case of storage device failure.

In accordance with a preferred embodiment of the present invention, no secret shares are stored at servers. In order to protect the private data, the data and a short password are encrypted using a special scheme, which combines the PPSS secret sharing phrase and an additional algorithm that involves applying asymmetric encryption to the secret shares and to some additional information. The result of this process is then stored locally on the client device.

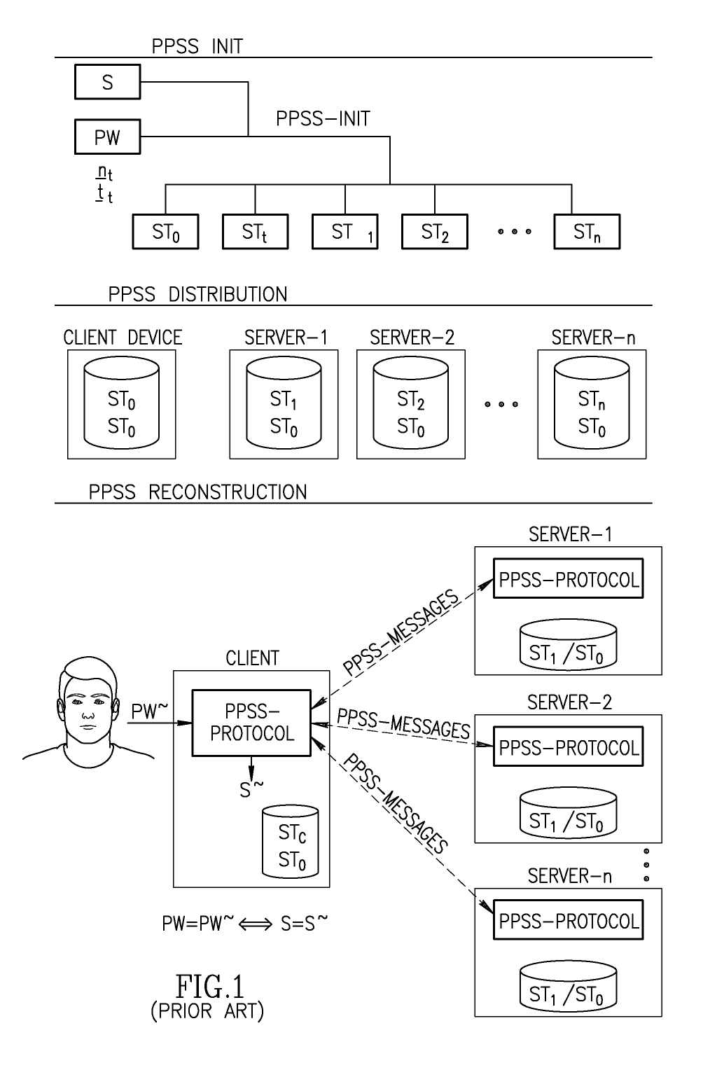

It will be appreciated that PPSS, in the private storage setting, comprises three processes as follows, illustrated in FIG. 1, to which reference is now briefly made:

1. PPSS-Init: an initialization process that takes a secret S, a password PW, parameters n and t, where n is the number of servers and t is a threshold, and produces a public state st₀ and private states St_{d}, St₁, . . . , Stₙ.

2. PPSS Distribution: following the initialization process, private state St_{d} is stored on the user's client device, private states Stᵢ are transmitted to the servers server, and public state St₀ is made available to all servers and the client device. We refer to the first two processes as the initial setup.

3. Reconstruction: this process is initiated by the user at her devi [symbol] password input, the device triggers a reconstruction protocol during which messages, denoted PPSS-messages, are exchanged between the device and at least t+1 servers. The protocol comprises 2 algorithms:

1. The PPSS-User algorithm, which is followed by the device; and

2. The PPSS-Server algorithm, which is followed by servers.

The PPSS-User and PPSS-Server algorithms define how PPSS-messages are computed by the parties and how the parties react to received PPSS-messages. At the end of the process, if and only if the password is correct, and provided that at least t+1 uncorrupted servers are accessible, the secret is reconstructed at the user's device. If the password is incorrect, the process results in a random value which reveals no information about the secret.

Note that ACM-978-1-4503-0948-Jun. 11, 2010 defines the notion of PPSS in the “private storage setting” in terms of 2n-t private server states (or shares) St₁, . . . , St₍₂ₙ₋ₜ₎, where n states are distributed to servers and n-t states are stored on the device, and the device plays the role of n-t servers during reconstruction. In terms of the definition of PPSS given hereinabove, the private state St_{d} consists of the collection of 2n-t server states that are assigned to the device. The definition given above is more general, as it allows for relying on more efficient implementations. One such implementation is presented below in the description of an embodiment of the present invention.

The present invention utilizes PPSS and enhances it with new elements in such a way that the following properties hold:

1. No data is distributed to servers following the PPSS-Init process. The initial setup can therefore be completed offline at the user's device, without exchanging information with any other machine. This property is achieved without any impact on the security of the system.

2. A throttling mechanism is applied as a measure against online diet

[symbol]

This prevents attackers who control the device from revealing the secret by repeatedly triggering the reconstruction protocol with different passwords. A major challenge related to throttling, which is addressed by the present invention, is ensuring that the servers' count of successive failed secret reconstruction attempts with different passwords remains accurate regardless of possible intermittent network connection problems and attacks that interfere with the communication between the client and the servers.

### Secret Protection System

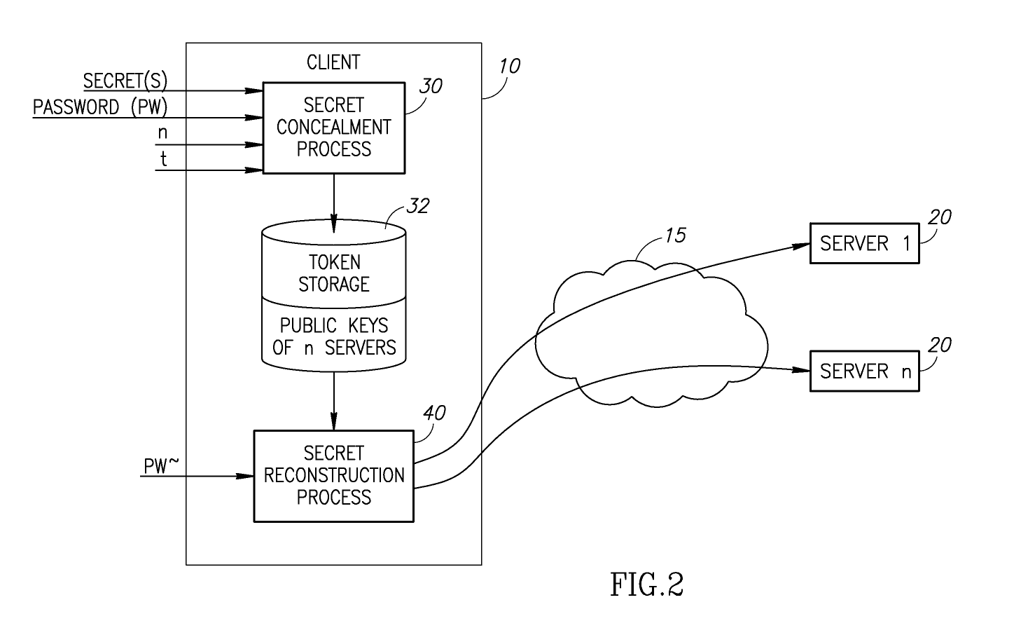

Reference is now made to FIG. 2 which shows a secret protection system of the present invention. As shown in FIG. 2, the system comprises one or more users' devices 10 (FIG. 1 shows one) and a collection of n servers 20 with which the user devices 10 may communicate through a network 15. The terms “de vice” and “client” are used interchangeably hereinafter.

A secret concealment process 30 is defined that takes place on a user's device. The process 30 accepts a secret S, a password PW, a list of n servers denoted server₁, server₂, . . . , serverₙ, a threshold t where t<=n, and produces output which is then stored locally in a storage unit 32 on the device. The password PW may be any type of identifying pattern, which may be alphanumeric, biometric, etc. The secret S may be any data which the user wants to keep secret.

A secret reconstruction process 40 is defined that starts and ends on the user's device 10. The reconstruction process 40 accepts a user provided password PW˜ and the output of the secret concealment process 30 from storage unit 32. During the secret reconstruction process 40, messages are exchanged between the device and some of the servers through network 15. If PW=PW˜ and if t+1 uncorrupted servers are accessible, then the output of the reconstruction process 40 is the secret S.

Each server 20 is assigned a unique pair of keys, a public encryption ke [symbol] decryption key. The public key is publically known and the private key is kept secret at the server.

The user's device is assigned a unique pair of a private signature key and a public validation key, denoted client-signature-key and client-validation-key respectively. The secret concealment process 30 may add the client-signature-key to the secret S. Alternatively the client-signature-key may be stored encrypted in such a way that S or part of S is required for decrypting it.

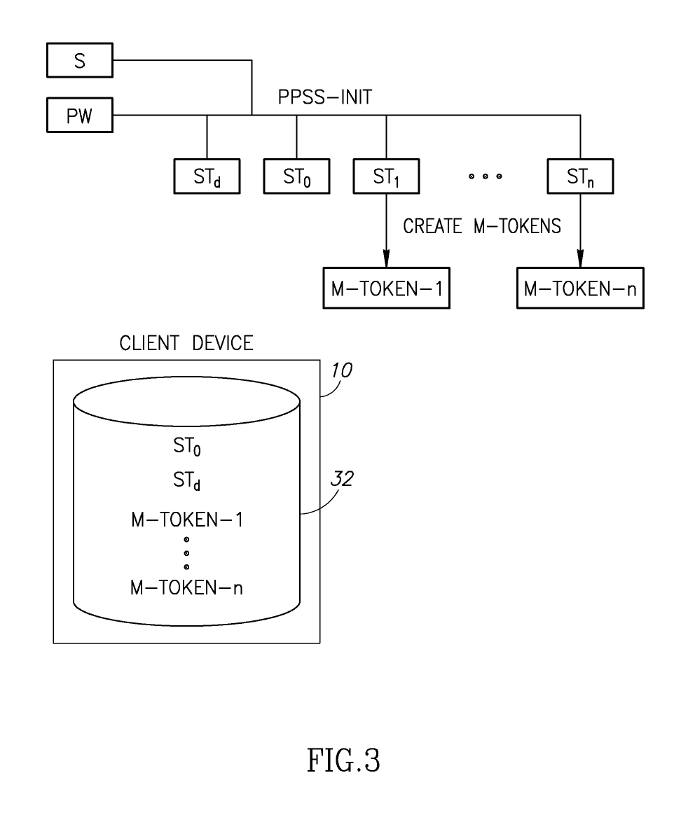

As shown in FIG. 3, to which reference is now made, secret concealment process 30 starts by applying the PPSS-Init process to password PW and secret S. Next, units of data, called “messenger tokens” and denoted m-tokenᵢ, which are to be associated with the ith server 20, are created. Each m-tokenᵢ contains state information which includes, but is not limited to:

1. The client-validation-key, or another unique identifier of the client

2. The PPSS private state Stᵢ

3. The PPSS public state St₀

4. Unique identifier of serverᵢ, such as the server's domain name

5. Success counter (could be 0 initially)

6. A signature on all the above. The signature is created using the client-signature-key and hence can be verified using the client-validation-key.

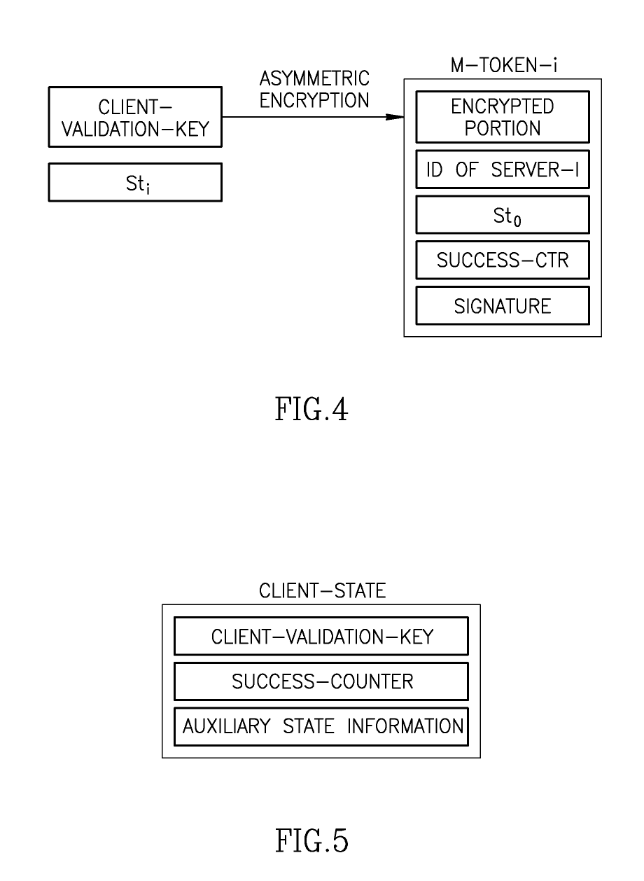

As shown in FIG. 4 to which reference is now briefly made, a portion of each m-tokenᵢ which includes at least the first 2 of the elements listed above is asymmetrically encrypted with the public key of its associated serverᵢ, so that only its associated server can read its content. Other elements of each m-tokenᵢ may or may not be included in the encrypted portion. Including the client's identifier in the encrypted portion may ensure that the encrypted po [symbol] used falsely by attackers in the context of another client.

FIG. 4 shows an exemplary m-tokenᵢ which comprises an encrypted portion, an identifier of associated serverᵢ, the state St₀, the current success counter (success_ctr) and a signature of all of the above.

Referring back to FIG. 3, the output of the secret concealment process 30 includes the states St_{d} and St₀, and the n m-tokens. The states St_{d} and St₀ may be combined into a base token. This data is stored locally, in storage unit 32. Secret concealment process 30 then removes S and PW from the memory of device 10.

In accordance with a preferred embodiment of the present invention, following every successful execution of the secret reconstruction process 40, the device 10 creates a new collection of signed ni-tokens with a higher success-counter value. The new collection is then stored locally in storage unit 32 instead of the last collection. Note that knowledge of the reconstructed secret is required in order to sign the new m-tokens.

During or prior to any execution of the secret reconstruction process that involves serverᵢ, the device 10 transmits the latest m-tokeni to its associated serverᵢ. Presenting a new m-token to a server 20 that participated in a former secret reconstruction process proves to the server 20 that the secret has been successfully reconstructed since then.

Each server 20 maintains a collection of client-states. As shown in FIG. 5, to which reference is now briefly made, a client-state contains, among other information, the client-validation-key and the last success-counter value that is known to the server, if such value is defined. Other auxiliary state information may also be stored, if desired.

During secret reconstruction, messages denoted MPSP-messages [symbol] between the device 10 and at least t+1 servers 20. An MPSP-message contains at least one of the following:

1. An m-token

2. A PPSS-message

MPSP-messages also contain metadata and sequencing information, which allows recipients (device 10 or servers 20) to handle them in the correct order and to identify replay attacks. MPSP-messages are transmitted in an encrypted form as a measure against various sorts of attacks.

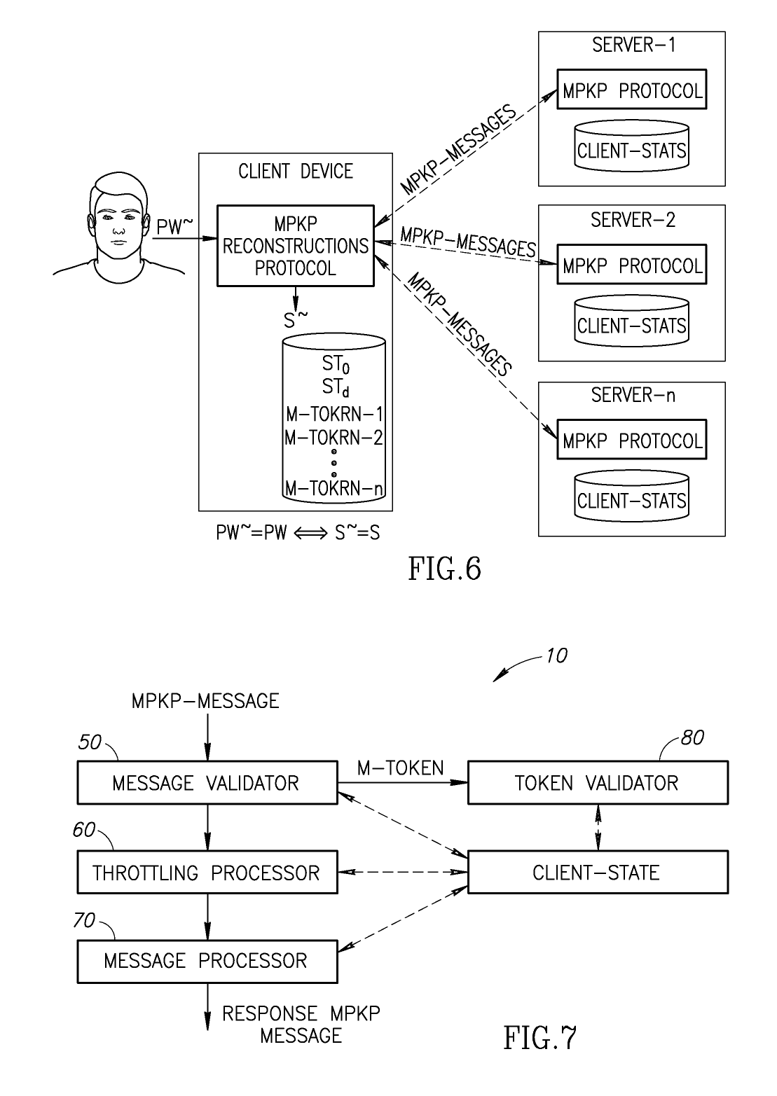

During secret reconstruction, controlled by reconstruction process 40 on the client 10 in conjunction with MPSP protocol units 42 on each server 20 and as illustrated in FIG. 6 to which reference is now briefly made, the client 10 and the servers 20 follow the PPSS-User and PPSS-Server algorithms respectively in order to create and respond to PPSS-messages. PPSS-messages are transmitted as payload inside MPSP-messages. As already noted, some MPSP-messages sent from the client 10 to a server 20 contain the latest m-token associated with that server 20. The exchange of MPSP-messages between the client 10 and one server 20 during the secret reconstruction process is referred to as a session.

As shown in FIG. 7 to which reference is now made, MPSP protocol units 42 of the servers may comprise various message processing modules for processing incoming MPSP-messages and m-tokens. Such modules include, but are not limited to a message validator 50, a throttling processor 60, a message processor 70 and a token validator 80. Any of the message processing modules may rely on the content of the client-state as input and may in turn modify the content of the client-state.

Token validator 80 may check the incoming m-tokens and may perform [symbol] tests:

1. That the contained server-identifier matches the present server

2. That the signature is valid

3. That the contained success-counter is greater or equal to the current success-counter in the client-state.

If any of the tests fails, the validation fails. Otherwise, if the success-counter in the m-token is greater than that found in the client-state, token validator 80 updates the value in the client-state with the higher value and also raises a success-event. The throttling processor 60 is informed with every success-event.

Message validator 50 verifies that the message's metadata and sequencing information match an expected incoming message. If the message contains an m-token, it is passed to the token validator 80 for validation. If any of the tests fails, message validator 50 discards the message.

Repeated-password proof: an essential property of PPSS is that servers are never exposed to information about users' actual passwords or passwords that are provided by users during secret reconstruction. However, in some cases, a client can provide a proof to a server that the password used during the secret reconstruction currently in progress is identical to the password used in a former reconstruction attempt that involved the server, even if the former attempt was aborted before completion. As presented below in a detailed description of an embodiment of the present invention, such proofs can be provided in a way that is both secure and verifiable by the server.

Throttling processor 60 performs the following steps on MPSP messages which have passed validation:

If since the last success-event, a former session with the same client ha [symbol] the present message contains no valid proof that the same password was used in the current and the former sessions, and if the present message is expected to contain such proof, then a foul-event is raised.

Depending on a recent history of foul-events and success-events, and according to a throttling policy being enforced, a decision is made whether to accept or reject the incoming message. For example, a throttling policy may apply, according to which any message that follows a series of 3 foul-events (and no success-events) is rejected.

If the message is rejected by the throttling processor 60, a rejection response is sent to the client 10.

Message processor 70 performs any remaining validation and processing as dictated by the PPSS-Server algorithm (and performed by PPSS server unit 72) on MPSP-messages which have passed validation and have not been rejected by the throttling processor. The message processor 70 may produce a response MPSP-message that is then sent to the client.

A variant of the secret protection method described above, presented hereinbelow, has the advantage of reduced computational cost related to m-token generation and validation. The variant includes the following adjustments to the method described above:

1. Instead of having the client-validation-key and the client-signature-key, the client 10 is assigned a unique identifier client-id and n distinct secret keys auth-key₁, auth-key₂, . . . , auth-keyₙ. The collection of auth-keyᵢ may be added to S by the secret concealment process 30 or stored encrypted in such a way that S or a part of S is required for its decryption.

2. Each m-tokenᵢ contains the following elements:

a. auth-keyᵢ

b. The PPSS private state Stᵢ

c. The PPSS public state St₀

d. The client-id

e. Unique identifier of server-i (such as the server's domain name)

f. Success counter (could be 0 initially)

g. Message authentication code (MAC) on the above elements. The MAC is generated with auth-keyᵢ as the key.

3. The encrypted portion of m-token; includes at least the first 2 of the elements listed above.

4. The client-state at server; contains auth-keyᵢ or a digest of it instead of the client-validation-key.

5. Validation of each m-tokenᵢ by server-i includes MAC validation instead of signature validation. The server 20 verifies that the auth-keyi value in m-tokeni matches the value in the client-state and then uses auth-key, to validate the MAC.

### Client-Side-State-Protection

Random network errors in network 15 (FIG. 2) during the progress of the secret reconstruction process 40 may force the client 10 to abort the protocol before completion. During the secret reconstruction process 40, the client 10 picks one or more values at random and uses these values in the computations that follow. As shown below in the description of a concrete embodiment of the invention, the ability of the client to prove to the servers that a secret reconstruction attempt which follows an aborted attempt is done with the same password as that of the aborted attempt, depends on the assumption that the client remembers the random values that were used during the former run. If this does not hold, servers 20 which participated in both runs will have to assume that the client tried different passwords, and thus count an extra foul against the client. In cases where the network 15 is unstable, the result might be that honest clients get locked out by the throttling processor 60. Attacks that inter [symbol] communication between the client 10 and the servers 20 might create a similar impact.

In order to avoid this, the client 10 needs to preserve the randomly picked values whenever the protocol is aborted due to network connection problems. However, due to possible threats (see explanation in the detailed description section below), any such value must be kept secret, if not destroyed. The purpose of the client-side-state protection method is to preserve the last used random values (the client-side-state) in a secure manner so that it can later be recovered, but only if the user has entered again exactly the same password as in the aborted attempt. Thus, as long as the password remains unchanged, successive reconstruction attempts that fail due to communication problems will not count against the user.

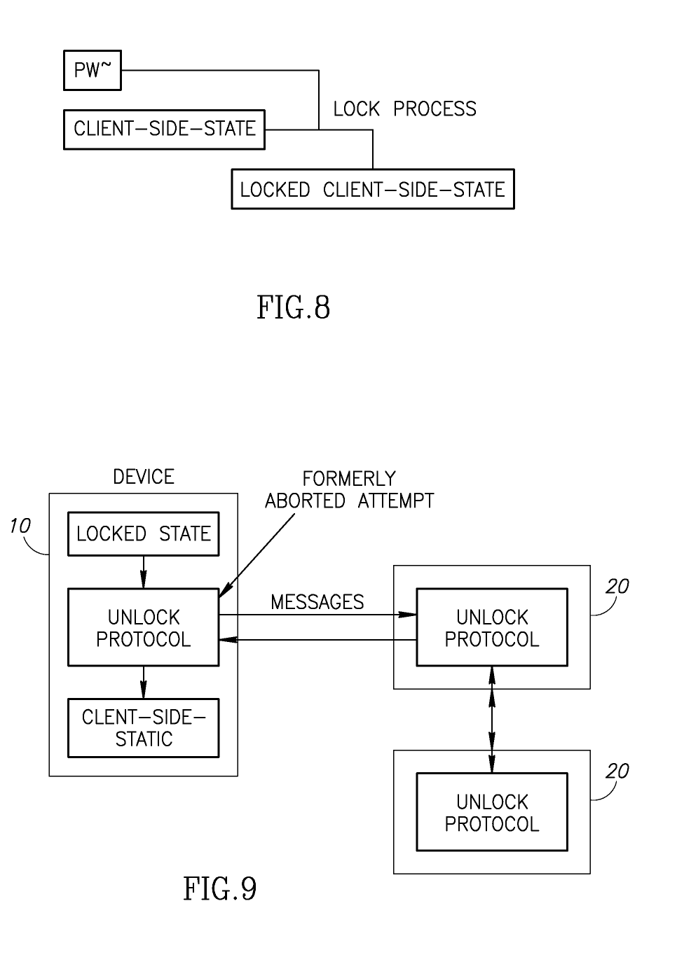

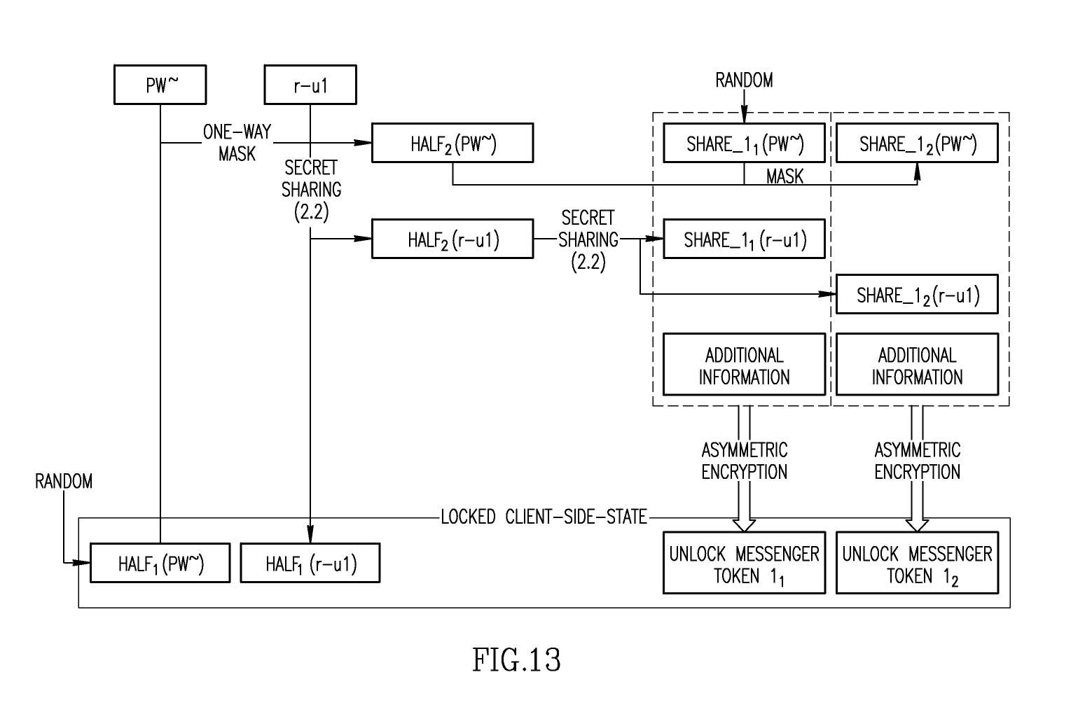

As shown in FIGS. 8 and 9 to which reference is now made and as described in more detail hereinbelow with respect to FIGS. 13-16, the method consists of an offline procedure (lock process) to lock the client-side-state and an online protocol (unlock protocol) to recover it. The input of the lock process is the client-side-state and the password PW used during the current, reconstruction process. The output of the lock process, denoted the locked client-side-state, is stored locally in storage unit 32. The input of the unlock protocol is the locked client-side state and a user provided password. The method is similar in principle to the secret protection method described above, except for a few essential differences:

1. Only 2 of servers 20, denoted “the unlock pair”, participate in the unlock protocol. The unlock pair is determined during the lock process.

2. During the unlock protocol, the client 10 communicates with at least one of the servers 20 of the unlock pair. The servers 20 of the unlock pair interact with each other in order to determine whether the provided password is the same as the password used earlier (before abort).

3. If the client 10 triggers the state-unlock protocol with a password [symbol] match the password used earlier (before abort), the servers 20 identify this and reject the request. The servers 20 then reject all unlock attempts that follow, regardless of the password.

4. The unlock-protocol can be restarted any number of times as long as the provided password matches the password used earlier (before abort). In case that the unlock protocol is aborted due to network errors, the client 10 can restart the reconstruction when the servers 20 become accessible again, with no impact on the level of security or correctness.

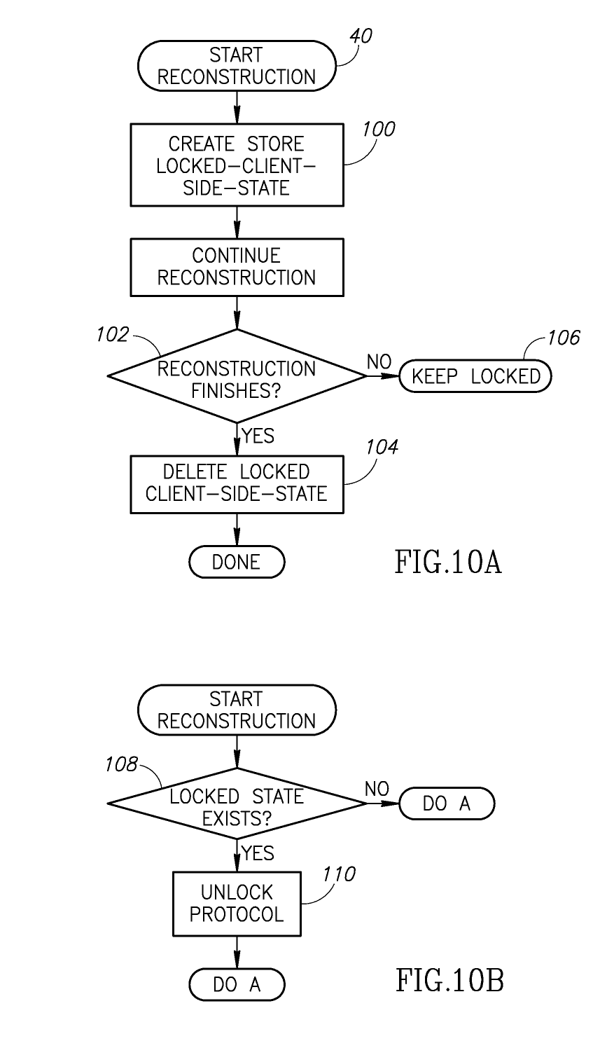

As shown in FIGS. 10A and 10B, to which reference is now briefly made, during the secret reconstruction process 40, immediately following the initial creation of the client-side state, the client performs (step 100) the client-side-state lock process and stores the output locally in storage unit 32. If the secret reconstruction process 40 completes successfully (performed in step 101 and checked in step 102), the formerly created locked client-side-state is deleted (step 104). Otherwise, the locked state is maintained (step 106). At the beginning of a secret reconstruction process 40, the existence of the locked state is checked (step 108). If the locked state doesn't exist, client 10 begins reconstruction with step 100 and cerates the locked-client-side-state. If the locked state exists (i.e. this is a reconstruction that follows a formerly aborted attempt), the client 10 triggers the unlock protocol (step 110). If the unlock succeeds, the client 10 continues with the reconstruction (step 101) and relies on the unlocked state to prove to the servers that the password has not changed since the aborted attempt. Note that the locked client-side-state only exists at the device for the duration that the servers 20 are not accessible.

It will be appreciated that the client-side-state protection method described with respect to FIGS. 13-16 generally guarantees that the protected client-side-state or password cannot be revealed unless the attackers gain control of the user's device and of [symbol] of the unlock-pair while the locked client-side-state exists on the device.

It will be appreciated that the present invention may have the following properties:

1. The secret concealment process is done offline at the user's client device without involvement of any other machine. Note that the underlying PPSS scheme lacks this property.

2. No sensitive information (except server's private keys) is ever stored at servers. This implies that leakage of data from servers' storage (even from all servers) does not risk users' protected secret data. Note that the underlying PPSS scheme lacks this property.

3. Throttling support: the system is designed to reject clients' secret reconstruction requests following a series of successive reconstruction attempts with different incorrect passwords. The method ensures that the count of incorrect password attempts remains accurate regardless of possible random network errors and attacks that interfere with the communication. Note that the underlying PPSS scheme lacks this property.

4. Redundancy and resilience: given the number of servers n and a predefined threshold t where 1<=t<n, the method ensures that as long as t+1 uncorrupted servers are accessible, users can access their secret data through their mobile devices. Moreover, since only information that relates to throttling statuses of clients is stored persistently at the servers, the system will continue to function even if all stored information is lost from all servers. Note that the underlying PPSS scheme lacks this property.

5. Password change by the user is possible when only t+1 uncorrupted servers are accessible where t+1 is the threshold. Note that the underlying PPSS scheme lacks this property.

6. Attackers who obtain control on a user's device will not be able to reveal any information about the user's protected data by any means including brute force attack, unless they also control t+1 servers or know the user's password.

7. Attackers who control all servers will not be able to learn anything a [symbol] protected data or password unless they also control the user's device.

8. Disaster recovery: the redundancy of the system allows for smooth recovery in case that some of the servers are destroyed (e.g. as a result of fire).

9. The redundancy of the system eliminates the need to keep backup copies of server's private keys. Having a single copy of each private key is crucial for protecting the system against hacking.

10. Relying on short passwords is safe. For example, 4-symbol auto-generated passwords may be used. The fact that no information about passwords is ever exposed to servers or stored on the client device makes it impossible to reveal passwords by means of offline dictionary attacks. Online dictionary attacks are also not possible due to the throttling mechanism.

11. The method is designed to support secure and smooth recovery of user's protected data following device theft or loss. The various methods of backup and recovery are not part of the present invention and are therefore not described in this document.

An embodiment of the presented invention is presented below.

### Secret Protection Method

### Term Definitions

PPSS: Password Protected Secret Sharing (PPSS), as defined in ACM-978-1-4503-0948-Jun. 11, 2010 (referred to as “the article” hereinafter)

PPSS₂: the article describes a detailed PPSS scheme, denoted PPSS₂, with properties as follows:

1. The scheme is applicable to public parameters n, t where n is the number of servers and t is the threshold, ten and t+1 servers are required in order to reconstruct the user's secret.

2. Init(p,s) generates public state st₀, and private states st₁, . . . , stₙ, that app [symbol] public parameters.

3. The Server algorithm consists of steps S1 and S2 and the User algorithm consists of steps U1 and U2, as follows:

4. S1 (performed by server Pᵢ1<=i<==n): this step receives the public state st₀, the private state stᵢ, picks a value r-s1ᵢ at random, computes a message M-S1ᵢ, and outputs r-s1ᵢ and M-S1ᵢ. M-S1ᵢ contains a proof that it has been constructed in conformance to the definition of S1 (proof of well-formedness).

5. U1: this step receives a password p, the public state st₀, a t+1 sized subset V of {1 . . . n}, messages M-S1ᵢ (the output of S1) for each i in V, a value r-u1 (r-u1 is picked at random by U before the execution of U1); and proceeds as follows:

a. Computes a component f(p˜,st₀,r-u1) where f is a function of p˜, st₀ and r-u1. This component is denoted (c_{p˜},d_{p˜},ĉ _{p˜}, d̂ _{p˜}) in the article and is referred to as the “password-component” hereinafter.

b. Computes t+1 distinct messages M-U1ᵢ where f(p˜,st₀,r-u1) is a component of M-U1ᵢ. M-U1ᵢ also contains a proof of well-formedness.

c. Outputs the messages M-U1ᵢ

6. S2 (performed by each server Pᵢ where i is in V): this step receives st₀, stᵢ, M-S1ᵢ (the output of S1), M-U1ᵢ (the output of U1), r-s1ᵢ (as picked during S1), and computes an output message M-S2ᵢ. M-S2ᵢ contains a proof of well-formedness.

7. U2: this step receives the public state st₀, the value r-u1 (which was picked before U1), the subset V of {1 . . . n} (same as in U1), the messages M-S1ᵢ, M-U1ᵢ, M-S2ᵢ (as produced by S1, U1 and S2) for each i in V; and produces an output s′.

Applicants note the following:

1. The randomly picked values r-s1ᵢ and r-u1 (denoted tⱼ and rp˜ [symbol] respectively), are in the Z_{q} space, where q is a public parameter of the scheme.

2. The above definition of PPSS₂ is slightly different than the article's definition. The differences are:

a. the value r-u1 is provided as input to U1 rather than being picked at random by U1

b. the subset V of {1 . . . n} is provided as input to U1 rather than being picked by U1. The subset V is assumed to correspond to a set of well-formed messages.

3. The Server algorithm stops at S2 if M-U1ᵢ contains an invalid proof of well-formedness.

4. The User algorithm aborts at U2 if at least one of the input messages M-S2ᵢ contains an invalid proof of well-formedness.

PPSS₃ a variant of PPSS₂ with modifications as follows:

1. Pᵢ is assigned a unique cryptographic pseudorandom permutation PRPᵢ which is kept secret at the server. A commitment value for PRPᵢ is computed and published.

2. In S1, instead of picking r-s1ᵢ at random, Pᵢ computes the value r-s1ᵢ by combining a value r-s0ᵢ, which it picks at random, with a one-time value r-u0ᵢ which is provided by U before S1. Combining the values is done as follows:

3. a hash function is applied to the concatenation of r-s0ᵢ and r-u0ᵢ.

4. PRPᵢ is applied to the result of the hash, the output of which is assigned to r-s1ᵢ. This guarantees that U has no influence on the actual value of r-s1ᵢ and Pᵢ has only limited influence on it.

5. The proof of well-formedness contained in M-S1ᵢ is modified in a way that allows U to verify conformance of Pi to the modified algorithm.

As shown below, these modifications allow U to securely provide serve [symbol] of a repeated password in case that the reconstruction protocol is aborted and restarted, e.g. due to connection problems between the client device and one of the servers.

Asymmetric encryption: the process of performing a cryptographic asymmetric encryption algorithm such as RSA.

Public/private encryption keys: cryptographic keys which are used for asymmetric encryption

Digital signature: this term refers to any of the following:

1. the process of executing a. digital signature algorithm such as RSA; and

2. the result of a applying a cryptographic digital signature algorithm to some input bit string.

Public/private signature keys: cryptographic keys which are used for digital signatures

Digitally signed content: a unit of data that contains:

1. arbitrary content.

2. a digital signature on the content.

Symmetric encryption: the process of performing a cryptographic symmetric encryption algorithm such as AES.

Symmetric encryption key: a cryptographic encryption key which is used for symmetric encryption.

Hash function: a cryptographic hash function such as SHA-3

Hash(X) where X is a bit string: the product of applying a hash function to x. Unless stated otherwise, all occurrences of the term hash(X) hereinafter relate to the same hash function.

Client device: a personal computing device such as smartphone or tab [symbol] client device has a display, a means of receiving user input (such as keypad or touch screen) and a network connection. The terms “client device” and “client” are used interchangeably hereinafter.

User: a person who relies on a client device in order to access personal private sensitive data such as private encryption keys.

Secret reconstruction server: a network node which adheres to the protocol described below. A secret reconstruction server plays a part in protection of users' sensitive data. Each secret reconstruction server is assigned a unique signature public/private key pair and a unique encryption public/private key pair. The private keys are stored at the server and the corresponding public keys are publicly known. The terms ‘secret reconstruction server’ and ‘server’ are used interchangeably hereinafter.

Server identity: information that enables nodes at a network to send private messages to a secret reconstruction server and/or to verify that certain messages were originated by the server. The server identity includes:

1. The network address (or another unique identifier) of the server. The address is required in order to send messages to the server over the network.

2. The server's public signature key and/or or public encryption key.

Secret reconstruction service (of size n): a network service that consists of multiple separate secret reconstruction servers. The number of servers and the identities of the servers that compose the secret reconstruction service (which can be a subset of a larger collection of servers) are determined by configuration settings at the client device. The number of servers that compose the secret reconstruction service is denoted n hereinafter.

ith server (or server-i) for i in {1 . . . n}: the secret reconstruction serv [symbol] according to some fixed order.

Reconstruction threshold: a number t between 1 and n−1 where t+1 is the minimum number of secret reconstruction servers that must participate in the process of reconstructing a user's secret data which is protected by the system. The reconstruction threshold is determined by configuration settings at the client device. The reconstruction threshold is denoted t hereinafter.

Underlying PPSS scheme: The PPSS₃ scheme as defined above with public parameters n, t where n is the size of the secret reconstruction service and t is the reconstruction threshold. The steps U1, U2, S1, S2 of the User and Server algorithms of the underlying PPSS scheme are denoted hereinafter PPSS₃-U1, PPSS₃-U2, PPSS₃-S1 and PPSS₃-S2 respectively. The Init algorithm is denoted hereinafter PPSS₃-Init (p,s). The outputs of PPSS₃-S1, PPSS₃-U1 and PPSS₃-S2 are denoted M-S1ᵢ, M-U1ᵢ and M-S2; respectively,

Message: a unit of data which is transmitted between nodes in a data communication network.

Secure authenticated connection: a cryptographically secured connection (such as SSL) between 2 nodes at a network where at least one of the nodes authenticates the other during the establishment of the connection in such a way that the authenticating node can validate that all data which is received through the connection has been sent by the authenticated node. Protocols (such as SSL) for establishing secure authenticated connections allow any node to authenticate the other with the help of a public signature key or a public encryption key of the authenticated node.

Private message (or privately sent message): a message transferred bet

[symbol]

network in such a way that only the designated recipient node can read the content of the message. Examples:

1. The message is sent over a secure authenticated connection.

2. The message is asymmetrically encrypted with a public encryption key of the recipient node. If the sender of the message is a client device and the message is expected to be answered with a response message from the recipient then the message includes a one-time symmetric encryption key that will be used by the recipient to encrypt the response. The sender picks the one-time symmetric key at random and keeps it in memory in order to decrypt the response message.

3. The message is encrypted using a symmetric encryption key which was previously sent in a private message from the recipient node to the sender node.

4. Encrypted pri vate messages are decrypted by the recipient before it starts processing them.

Authenticated message: a message which is transmitted between nodes at a network in such a way that the recipient of the message can validate that the message has been generated by the sender. Examples:

1. The message is transmitted over a secure authenticated connection.

2. The message is digitally signed using a private signature key of the sender and the corresponding public key is known to the recipient. The signature is validated by the recipient before starting to process it.

Password: this term refers to any of the following:

1. A secret sequence of symbols that is known to a user and presumably only to the user (a text password).

2. A sequence of symbols that is derived from secret information that [symbol] user and presumably only to the user.

3. biometric data (such as properties of a person's fingerprint) that identifies a user

The password is provided by the user through input means (such as touch screen) of the client device.

Password encoding scheme: a set of rules that defines the representation of passwords as fixed length bit strings. The length of the bit string representation of passwords is referred to hereinafter as the ‘password length’. A possible password encoding scheme defines the bit string representation of a text password as the sequence of Unicode codes of the password's symbols, followed by the space character's Unicode code, followed by zeroes such that the total length of the bit string is equal to the password length.

PW: the bit string representation of the user's password. PW complies with the password encoding scheme as defined above,

PW˜: the bit string representation of a password provided by the user when required to do so for the purpose of secret reconstruction. PW˜ complies with the password encoding scheme as defined above.

Password mask operator: a computable operator M that takes two bit strings of length L, where L is the password length, and produces a 3rd bit string of length L, such that for any bit strings a, b, c of length L, if b< >c then M(a,b) < > M(a,c) and M(b,a) < > M(c,a). Bitwise xor is an example of a password mask operator.

half₁(PW): a bit string of length L where L is the password length. half₁(PW) is picked at random by the client during the secret concealment process as described below.

half₂(PW): the result of applying the password mask operator to PW and half₁(PW).

half₂(PW˜): the result of applying the password mask operator to PW and half₁(PW).

MainKey: a secret symmetric encryption key or asymmetric decryptio [symbol] required for decryption of encrypted private sensitive data that belong to a user of a client device. As described below, MainKey is protected in such a way that it cannot be revealed by anyone who controls the client device unless they also know the user's password.

MPSP encrypted data: data that is stored at the client device or elsewhere in encrypted form such that MainKey is required for its decryption. Note that MPSP encrypted data cannot be accessed without knowledge of the user's password.

Client-validation-key and client-signature-key: a pair of public and private signature keys that a client device assigns to itself. The key pair is stored locally at the device. The client-signature-key is MPSP encrypted.

Persistent variable: a variable which is stored in non-volatile storage of a client device or a server. Non-volatile storage can retain stored information even when not powered.

Success-counter: a persistent variable at the client device that counts the number of successful secret reconstruction attempts. The success-counter gets incremented each time that MainKey is reconstructed at the client-device, as described below.

Shutoff threshold: a persistent configuration variable at the client device that denotes the maximum number of successive failed key restoration attempts before the secret reconstruction sendee blocks additional secret reconstruction attempts.

Selected subset: a t+1 sized subset of {1 . . . n} where n is the size of the secret reconstruction service and t is the reconstruction threshold. The selected subset is determined bv the client device during the secret reconstruction process as described below.

Corrupted subset: a persistent variable at the client device which contains a subset of {1 . . . n}. The corrupted subset corresponds to servers that have been identified as corrupted. The method by which the client identifies a server as corrupted is described below.

Secret sharing (k, n) where n and k are positive integers and n>=k: an [symbol] transforms a bit string (the secret) into n bit strings (the shares) so that the following conditions are satisfied:

1. The values of the shares cannot be predicted by external observers.

2. The secret is computable from any k shares.

3. No information about the secret can be derived from any set of less than k shares.

4. Or (alternatively to 3), deriving any information about the secret from any set of less than k shares is infeasible.

Shamir's Secret Sharing algorithm is a known example of a secret sharing algorithm that fulfills 3 above.

half₁(MainKey), half₂(MainKey): the result of applying secret sharing(2,2) to MainKey

st₀(MainKey,PW) and stᵢ(MainKey,PW) for i in {1 . . . n}: the products of applying the PPSS₃-Init(p,s) algorithm to half₂(PW) and half₂(MainKey)

r-s1; for i in {1 . . . n}: values which are picked at random by the servers, rs-1ᵢ is picked by the ith at server certain points during the secret reconstruction process as described below.

M-S1ᵢ for i in {1 . . . n}: the product of applying the PPSS₃-S1 step to st₀(MainKey,PW), stᵢ(MainKey,PW) and r-sli. The values M-S1₁ are computed by the ith server during the secret reconstruction process as described below.

r-u0ᵢ for i in {1 . . . n}: variables at the client-device. The values of r-u0ᵢ are picked at random during the secret reconstruction process as described below.

r-u1: a variable at the client-device. The value of r-u1 is picked at random during the secret reconstruction process as described below.

M-U1ᵢ where i is in the selected subset: the product of applying the PP [symbol] half₂(PW˜), st₀(MainKey,PW), the selected subset, M-S1ᵢ and r-u1. As mentioned above, M-U1ᵢ contains a value which is referred to as the password-component.

M-S2ᵢ where i is in the selected subset: the product of applying the PPSS₃-S2 step to st₀(MainKey,PW), stᵢ(MainKey,FW), r-s1ᵢ, M-S1ᵢ and M-U1ᵢ.

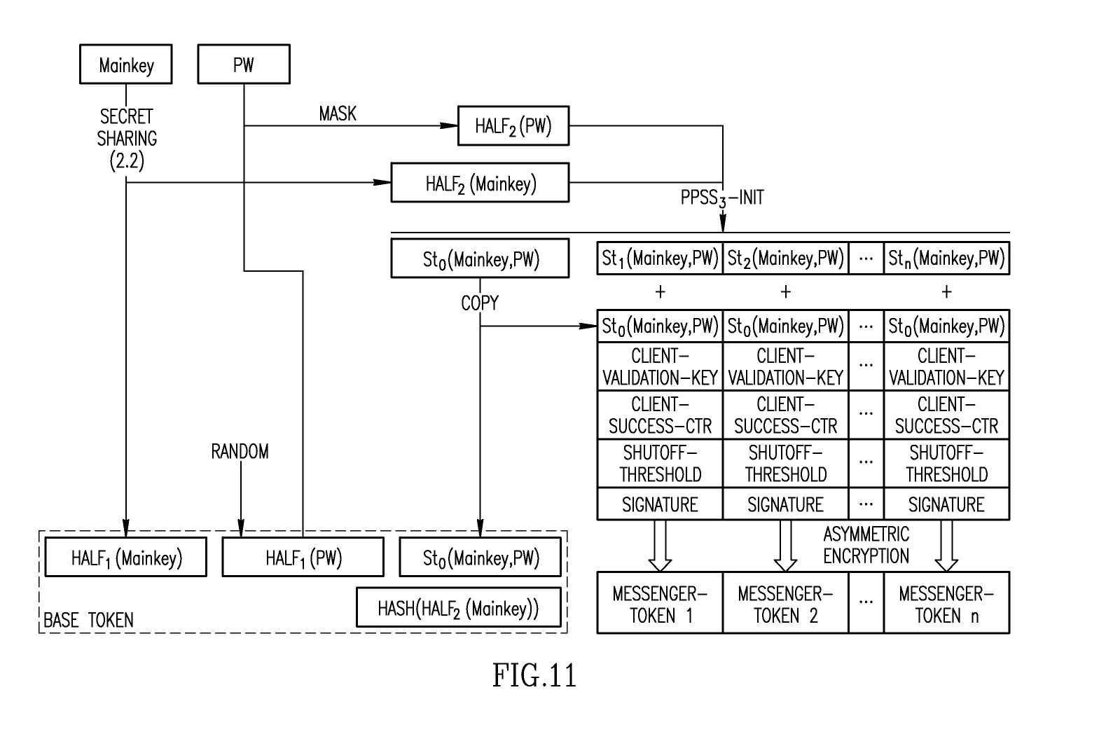

Base token: as shown in FIG. 11, to which reference is now made, a unit of data that consists of the following elements:

1. half₁(FW)

2. half₁(MainKey)

3. Hash(half₂(MainKey))

4. st₀(MainKey,PW)

ith private-portion: as shown in FIG. 11, a unit of data that consists of the following elements:

1. stᵢ(MainKey,PW)

2. Hash(client-validation-key)

3. The ith private-portion is asymmetrically encrypted with the ith server's public encryption key.

ith messenger-token for i in {1 . . . n}: as shown in FIG. 11, a unit of data that consists of the following elements:

1. The client-validation-key

2. stᵢ(MainKey,PW)

3. st₀(MainKey,PW)

4. The current value of the success-counter

5. The value of the shutoff threshold

6. Additional information (optional)

7. Digital signature on all the above elements. The signature is created using the client-signature-key.

The ith messenger-token is asymmetrically encrypted with the ith server's public encryption key.

ith retry-counter for i in {1 . . . n}: persistent integer variables at the client device. The ith retry-counter is incremented at certain points in the secret reconstruction process as described below.

ith request-phase-1 where is i in {1 . . . n}: a message that is sent from the client device to the ith server during the secret reconstruction process as described below. The ith request-phase-1 consists of the following elements:

1. r-u0ᵢ

2. ith messenger-token

3. Current value of the ith retry-counter

ith response-phase-1 where i is in {1 . . . n}: a message that is sent from the ith server to the client device as part of the secret reconstruction process as described below. The ith response-phase-1 consists of the following elements:

1. M-S1ᵢ

2. Last value of the ith retry-counter

ith request-phase-2 where i is in the selected subset: a message that is sent from the client device to the ith server during the secret reconstruction process as described below. The ith request-phase-2 consists of the following elements:

1. Client-validation-key

2. Hash(request-1) where request-1 is the last sent ith request-phase-1

3. One of the following:

3a. M-U1ᵢ

3b. Rejection indication

3c. Unexpected request indication

ith response-phase-2 for i in {1 . . . n}: a message that is sent from the ith server to the client device as part of the secret reconstruction process as described below. The ith response-phase-2 consists of the following elements:

1. One of the following:

1a. M-S2ᵢ

1b. Rejection indication

2. Last value of the ith retry-counter

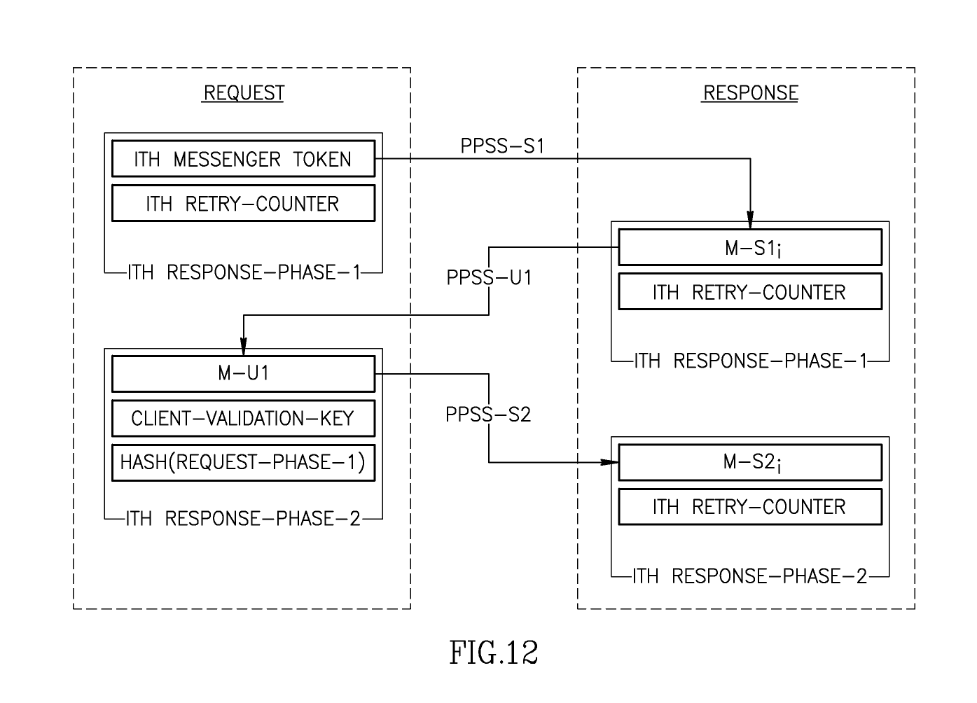

FIG. 12 depicts the ith request-phase-1, ith request-phase-2, ith-response-phase-1 and ith response-phase-2.

Server-side-state repository: each of the secret reconstruction servers maintains a local repository of server-side states of clients. The server side state repository contains entries (records) for clients that interacted with the server in the past. The state repository is indexed by the client-validation-key, i.e. the client-validation-key is used for looking up entries in the state repository. Each entry of the ith server's state repository contains the variables listed below. The first 5 variables are persistent.

1. [persistent] Last seen value of the success-counter (the initial value is 0)

2. [persistent] Last seen value of the client's ith retry-counter (the initial value is 0)

3. [persistent] Hash(pwc) where pwc is the password-component of M-U1ᵢ and M-U1; is taken from the last processed ith request-phase-2.

4. [persistent] Foul counter: the number of successive reconstruction rec [symbol] client that did not pass validation of the password-component as described below. The initial value is 0.

5. [persistent] Shutoff flag: a flag that indicates whether the client is blocked for requests by the server. Possible values are ‘shut’ and ‘open’. The initial value is open.

6. The last processed ith request-phase-1

7. Last value of r-s1ᵢ (as defined above) that was picked by the server for this client

8. Last ith response-phase-1 that was sent to the client

9. Hash(request-2) where request-2 is the last processed ith request-phase-2

10. Last ith response-phase-2 that was sent to the client

11. Additional information (optional)

The terms “server-side-state repository” and “repository” are used interchangeably hereinafter.

Abort-timeout: the maximum amount of time that can elapse since the beginning of the secret reconstruction process as described below until the protocol completes or aborts. The abort-timeout is determined by configuration settings at the client device.

Restart-timeout: the amount of time that a client waits between sending the first request-phase-2 until receiving all expected response-phase-2s and before restarting the secret reconstruction process as described below. The restart-timeout is determined by configuration settings at the client device.

Resend-timeout: the amount of time that a client waits between sending the last request-phase-1 or request-phase-2 until receiving the corresponding response and before resending the unresponded request. The resend-timeout is determined by configuration settings at the client device.

### Secret Concealment Process

The secret concealment process is a transformation that the client device performs on MainKey and PW (the secret key and the password) in order to store them securely. The process is carried out by the client without involvement of any other machine. FIG. 11 depicts the secret concealment process, which proceeds as follows:

1. Client: creates half₁(MainKey) and half₂(MainKey) by applying secret sharing to MainKey and computes hash(half₂(MainKey))

2. Client: picks half₁(PW) at random and creates half₂(PW) by applying the password mask operator to PW and half₁(PW)

3. Client: performs PPSS₃-Init(half₂(PW),half₂(MainKey)) to produce st₀(MainKey,PW) and stᵢ(MainKey,PW) for i in {1 . . . n}

4. Client: increments the value of the success-counter

5. Client: uses MainKey to access the client-signature-key (which is MPSP encrypted). The client-signature-key is required for signing the messenger-tokens.

6. Client: creates the base token and the ith messenger-token for i in {1 . . . n} and stores them locally.

7. Client: removes MainKey, PW and the client-signature-key from memory.

### Secret Reconstruction Process

The secret reconstruction process is initiated by the client whenever a user performs an operation that requires access to MainKey. In this event, the client device requests the user to enter the password. The purpose of the process is to reconstruct MainKey, given the password as entered by the user, denoted PW, and the products of the secret concealment process, as described above. During the process, the client and the servers follow a protocol, denoted secret reconstruction protocol, which consists of 3 sub protocols as follows:

### Client Secret Reconstruction Sub-Protocol:

This sub-protocol defines the client's part in the secret reconstruction protocol. This sub-protocol relies on the following set of local variables:

1. PW˜ as defined above

2. half₂(PW) as defined above

3. Last value of r-u0ᵢ for i in {1 . . . n} as defined above

4. r-u1 as defined above

5. The selected subset, as defined above

6. Collection of sent request-phase-2s

7. Collection of received valid response-phase-1s and response-phase-2s

8. Reject subset—a subset of {1 . . . n} that corresponds to servers which rejected the client.

All local variables are automatically deleted from memory when the secret reconstruction process is completed or aborted. Given PW˜ and the products of the secret concealment process as described above, the client secret reconstruction sub protocol proceeds as follows:

1. Picks a set S of members i of {1 . . . n} such that:

a. i is not in the corrupted servers.

b. i is not in the reject subset.

c. the ith response-phase-1 is not included in the local collection of received valid response-phase-1s

d. the sum of the number of collected valid response-phase-1s and the size of the set S is at least t+1 where t is the reconstruction threshold.

If no such set exists, then outputs an error indication and stops.

2. For each i in the set S:

a. increments the value of the ith retry-counter

b. picks a value at random, assigns it to of r-u0ᵢ

c. creates an ith request-phase-1 and sends it to the ith server privately.

3. Waits to receive the ith response-phase-1s for any i in S. Note that ail messages from a server to a client are sent privately and authenticated. For each received message, performs validation as follows:

i. Compares the ith retry-counter value in the received message with the local value of ith retry-counter. If the values are different then the message is discarded.

ii. If the received ith response-phase-1 contains rejection indication then adds i to the reject subset and discards the received message. Otherwise extracts M-S1ᵢ from the received message and validates the contained proof of well-formedness. If this validation fails then adds i to the corrupted subset and discards the response message.

iii. If the sum of the size of the reject subset and the size of the corrupted subset exceeds n-k then outputs error indication and stops.

if less than t+1 (t is the reconstruction threshold) valid response-phase-1s could be collected within the abort-timeout since the beginning of the protocol then outputs error indication and stops.

If less than t+1 valid response-phase-Is could be collected within the resend-timeout since sending the last request-phase-1 then goes back to step i.

4. Assigns the subset of {1 . . . n} that corresponds to the first t+1 received valid ith response-phase-Is to the selected subset.

5. If the value of r-u1 is not defined then picks a value at random and as:

[symbol]

Note: reusing the last value of r-u1 allows servers verify that PW has not changed since the previous interaction with the client.

6. Computes half₂(PW) from FW and half₁(PW).

7. Extracts M-S1; from the ith response-phase-1 for each i in the selected subset and performs PPSS₃-U1 to produce the values M-U1ᵢ.

8. For each i in the selected subset creates the ith request-phase-2, adds it to the collection of sent messages and sends it to the ith server privately.

9. Waits to receive the ith response-phase-2 for any i in the selected subset. For each received message, performs validation as follows:

a. Compares the ith retry-counter value in the received message with the local value of the ith retry-counter. If the values are different then the message is di scarded.

b. If the received ith response-phase-2 contains rejection indication then adds i to the reject subset. Otherwise extracts M-S2ᵢ from the received response message and validates the contained proof of well-formedness. If the validation fails, then

i. adds i to the corrupted subset. If this step fails (i is in the reject subset or in the corrupted subset) then:

ii. clears the selected subset, the collection of sent request messages and the collection of received response messages.

iii. starts the protocol over from step 1.

c. Adds the message to the collection of received response-phase-2s.

If less than t+1 valid response-phase-2s could be collected within the abort-timeout since the beginning of the protocol then outputs error indication and stops.

If less than t+1 valid response-phase-2s could be collected within the [symbol] since the beginning of the current step then:

i. removes from memory the selected subset, the collection of sent request messages and the collection of received response messages.

ii. starts the protocol over from step i.

If less than t+1. valid response-phase-2s could be collected within the resend-timeout since sending the last request-phase-2 then:

i. for each i in the selected subset such that the ith response-phase-2 is absent, resends the last sent ith request-phase-2 to the ith server.

ii. repeats the current step.

10. Extracts M-S2ᵢ from the ith response-phase-2s where i is in the selected subset and performs PPSS₃-U2 which produces an output s.

11. Computes hash(s) and verifies that the result is identical to the locally stored hash(half₂(MainKey)). If this validation succeeds then MainKey is reconstructed from its shares half₁(MainKey) and half₂(MainKey). Otherwise, outputs an indication to the user that the provided password is incorrect.

12. If the previous step completes successfully then removes the base token and the messenger-tokens from memory and performs the secret concealment process, which produces a new base token and a new collection of messenger-tokens.

Server secret reconstruction phase-1 sub-protocol:

This sub protocol defines how the ith server processes an incoming ith request-phase-1.

1. ith server: receives the ith request-phase-1, decrypts the contained m [symbol] and verifies that the digital signature in the messenger-token is valid and matches the contained client-validation-key. Otherwise, stops the processing of the request.

2. ith server: uses the client-validation-key from the messenger-token to lookup the appropriate server-side-state in its local repository. If no matching entry is found in the repository then creates a new entry for the client and populates it with the relevant information from the request. The term ‘client-entry’ is used hereinafter to refer to the said entry in the server-side-state repository.

3. ith server: checks the shutoff flag in the client-entry. If the current value is ‘shut’ then creates a response-phase-1 with rejection indication and the value of the ith retry-counter from the received request, sends it to the client and stops the processing of the request. The response is transmitted privately and authenticated.

4. ith server: compares the value of the success-counter in the received messenger-token to that found in the client-entry. If the first is smaller than the latter then stops the processing of the request. If the first is bigger than the latter then:

a. Resets the client-entry (all previous content is deleted and all variables receive the default values).

b. Updates the following variables in the client-entry:

i. Last ith request-phase-1

ii. The success-counter

iii. ith retry-counter. The new value is taken from the received request

5. ith server: extracts the value of the ith retry-counter from the received request message and compares it with the value found in the client-entry. If the first is smaller than or equal to the latter then stops the processing of the request. Note that replayed re [symbol] are discarded. If the first is bigger than the latter then:

a. Clears the non-persistent variables in the client-entry.

b. Updates the retry-counter value in the client-entry to the bigger value.

c. Updates the last ith request-phase-1

6. ith server: extracts the ith messenger-token from the received request-phase-1, extracts st₀(MainKey,PW), stᵢ(MainKey,PW) from the messenger-token, performs PPSS₃-S1 which outputs r-s1ᵢ and M-S1ᵢ and stores r-s1ᵢ in the client-entry.

7. ith server: creates the ith response-phase-1 (based on the last values of the ith retry-counter and M-S1ᵢ), stores it in the client-entry and sends it to the client. The message is sent privately and authenticated as per the above definitions of these terms.

Server Secret Reconstruction Phase-2 Sub-Protocol:

This sub protocol defines how the ith server processes an incoming ith request-phase-2. Note that the server accepts a replayed request-phase-2 if it matches the last received request-phase-2 from the sending client.

1. ith server: extracts the client-validation-key from the incoming request and uses it to lookup the client's entry in the local server-side-state repository. If no matching entry is found in the repository then stops the processing of the request. The term ‘client-entry’ is used hereinafter to refer to the said entry in the server-side-state repository.

2. ith server: checks the shutoff flag in the client-entry. If the current value is ‘shut’ then stops the processing of the request.

3. ith server: if the client-entry does not contain a last processed ith request-phase-1 then stops the processing of the request.

4. ith server: extracts the last processed ith request-phase-1 from the c [symbol] hash(request-1) from the received request-phase-2, applies hash to the first and compares the values. If the values do not match then stops the processing of the request.

5. ith server: if the client-entry contains hash(request-2) then applies hash to the received message and compares the values. If the values are different then stops the processing of the request. If the values match then extracts the last sent ith response-phase-2 from the client-entry, re-sends it to the client and stops the processing of the request.

6. ith server: extracts M-Uli from the received ith response-phase-2 and validates the contained proof of well-formedness. If the validation fails then stops the processing of the request.

7. ith server: extracts the password-component from M-U1ᵢ and applies hash to it. If the value of hash(pwc) in the client-entry is not defined or different from the computed hash then increments the foul counter in the client-entry and sets the value of hash(pwc) in the client-entry to the computed value.

8. ith server: extracts the shutoff threshold from the ith messenger-token. If the value of the foul counter in the client-entry exceeds the shutoff threshold then sets the value of the shutoff flag to ‘shut’, creates a response-phase-2 with rejection indication and the value of the ith retry-counter from the received request, sends it to the client and stops the processing of the request. The response is transmitted privately and authenticated. Comment: the decision whether and when the server shuts off a client can be done based on other factors except the value of the foul counter. Also, different throttling policies may apply, according to which the server temporarily rejects client's requests before enforcing permanent shutoff.

9. ith server: applies hash to the received ith request-phase-2 and stores the result in the client-entry.

10. ith server: applies PPSS₃-S2 to st₀(MainKey,PW), stᵢ(MainKey,P [symbol] U1ᵢ, r-s1ᵢ to produce M-S2i and creates the ith response-phase-2 with the computed M-Sᵢ.

11. ith server: stores the created ith response-phase-2 in the client-entry and sends it to the client. The message is transmitted privately and authenticated.

Comment about disruption protection: the fact that the secret reconstruction protocol involves 2 communication rounds between the client and each server means that a corrupted server can disrupt the protocol by not responding to request-phase-2s. In such case, the client will be forced to start the protocol over in attempt to complete the secret reconstruction process. Unless the corrupted server is excluded from the selected subset, this type of attack can cause the client to repeatedly fail to complete the protocol. In order to minimize the impact of such attacks, the client must identify servers that consistently do not respond to request-phase-2s and add them to the corrupted subset. In order to do that, the client counts, for each server, the number of times and the frequency of sessions in which an expected request-phase-2 is not received.

Comment about PPSS in the private storage setting: the secret protection method described above, which utilizes PPSS₃, can also be described in terms of PPSS in the “private storage setting”, where the output of the PPSS-Init process includes private states St_{d}, St₁, . . . Stₙ. We define such a PPSS scheme as a valiant of PPSS₃ with adjustments as follows: PPSS-Init includes an additional preliminary step of splitting the secret s into halfi(s) and hallos) and splitting the password PW into half₁(PW) and halfjCPW) as described above. The device state St_{d} comprises half₁(PW) and half₁(s). The PPSS-User algorithm is also modified: it begins with computing half₂(PW˜) from PW˜ and half₁(PW), proceeds according to the definition of PPSS₃ with half₂(PW˜) taken as input instead of PW-, and ends with combining the reconstructed half₁(s) and half₂(s) into s.

comment about throttling: the fact that client shutoff is enforced t [symbol] independently of other servers means that even if a client is shut off by some servers, there may be other servers that will allow the client to perform additional reconstruction attempts. Furthermore, corrupted servers, if such exist, may not enforce throttling at all. The actual upper bound to the number of possible password guesses is given by the expression th*(n−bad)/(t+1−bad) where th is the shutoff threshold and bad is the number of corrupted servers that do not enforce throttling.

### Client-Side-State Protection

During the secret reconstruction process 40, the client picks the value r-u1 at random and uses that value in the computations that follow. The ability of the servers to detect that 2 successive unsuccessful runs of the protocol are done with the same password depends on the assumption that r-u1 remains unchanged between the first and the second run. If this does not hold, servers which participated in both rounds will have to assume that the client tried different passwords, and that would impact the accuracy of the foul count. For this reason, the client needs to preserve the last value of r-u1 whenever the protocol is aborted due to temporary network errors. A difficulty arises due to the fact that the combination of r-u1, half₁(pw) and the password-component can be used to reveal the password via offline dictionary attack. Since all servers are exposed to the password-component during the secret reconstruction protocol, and since half₁(pw) is regularly stored at the client, any past used value of r-u1 must be kept secret, if not destroyed.

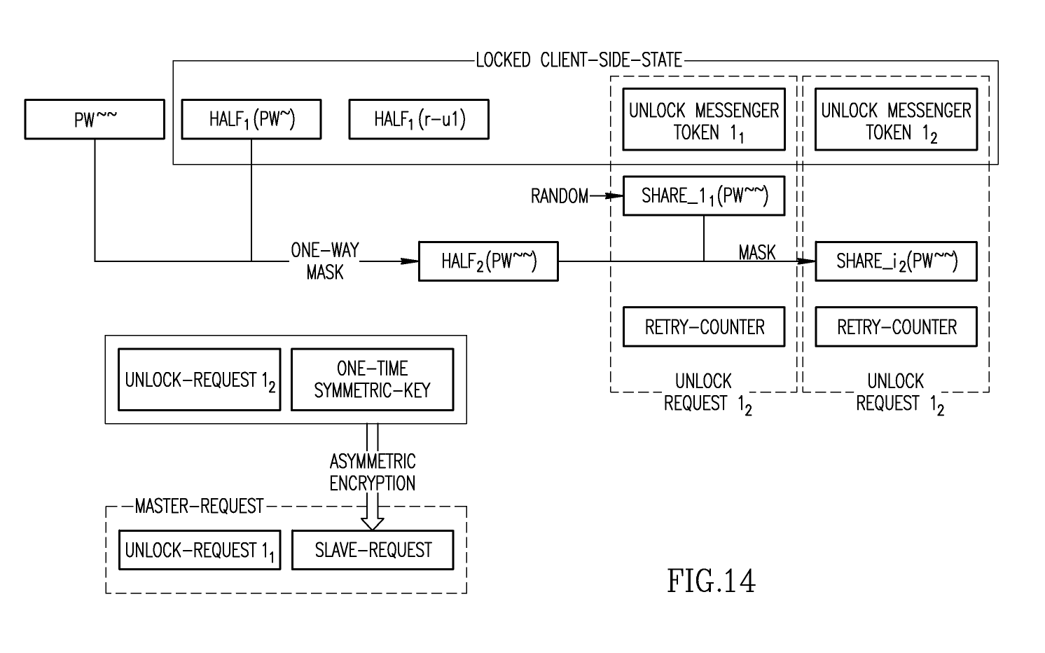

Reference is now made to FIGS. 13, 14, 15 and 16 which illustrate a client-side-state protection method which attempts to preserve the last value of r-u1 (the client-side-state) in a secure manner so that it can later be recovered, but only if the user has entered again exactly the same password as in the aborted attempt. The method consists of an offline procedure (lock process, shown in FIG. 13) to lock the client-side-state and an online protocol (u [symbol] shown in FIGS. 14-16) to recover it.

### Term Definitions

Unlock pair: a pair (i₁,i₂) where i₁ and i₂ are in {1 . . . n}. i₁ and i₂ are picked at random during the client-side-state lock process as described below, i₁ and i₂ are referred to hereinafter as the master-index and the slave-index respectively. Server-i₁ and server-i₂ are referred to hereinafter as the master-server and the slave-server.

The jth server's role where j is in the unlock pair: the symbol ‘master’ if j is the master-index or the symbol ‘slave’ if j is the slave-index.

One-way mask operator: a computable operator M that takes 2 bit strings and produces a fixed length bit string such that the following conditions are satisfied:

1. For any bit strings a, b, c if a< >b then the probability that M(a,c)=M(b,c) is negligible,

2. For any bit strings a, b where b is picked at random from a sufficiently large set, deriving information about a (other than information which is given in advance) from M(a,b) is infeasible.

3. For any finite set of bit strings A and a bit string b where b is picked at random from a sufficiently large set, deriving information about A (other than information which is given in advance) from the collection of values M(a,b) where a belongs to A is infeasible.

Example of a one-way mask operator M: M(a,b)=hash(concat(a,b)) where concat(a,b) is the concatenation of a and b and hash is a secure hash function.

Reversible mask operator (L) where L is a positive integer: a computable operator M that takes 2 bit strings of length L and produces a 3rd bit string of length L such that the following conditions are satisfied:

1. For any bit strings a, b, c of length L, if b< >c then M(a,b) < > M(a,c) [symbol] M(c,a)

2. A second computable operator M′ exists (inverse operator) such that M402 (M(a,b),b)=a for any bit strings a, b of length L

3. A third computable operator M″ exists (difference operator) such that for any bit strings a,b,c,d of length L if M′(b,a)=M′(d,c) then M″(b,d)=M″(a,c)

Bitwise xor is an example of a reversible mask operator M where M(a,b), M′(a,b) and M″(a,b) are all defined as a x or b.

Password one-way mask operator: a one-way mask operator as defined above. The password one-way mask operator is denoted hereinafter ow_mask(a,b).

Password reversible mask operator: a reversible mask operator (L) as defined above where L is the length of the password one-way mask operator's output. The password reversible mask operator and its corresponding inverse operator and difference operator are denoted hereinafter mask(a,b), unmask(a,b) and diff(a,b) respectively.

PW˜: the bit string representation of a user's password as entered by the user prior to the initiation of the secret reconstruction protocol.

The following terms are shown in FIG. 13.

half₁(PW˜): a randomly picked bit string of length L where L is the length of the password one-way mask operator's output.

half₂(PW˜): the result of applying the password one-way mask operator to PW˜ and half₁(PW˜): half₂(PW˜):=ow_mask(PW˜,half₁(PW˜)).

share-i₁(PW˜) where (i₁,i₂) is the unlock pair: a randomly picked bit string of length L where L is the length of the password one-way mask operator's output.

share-i₂(PW˜) where (i₁,i₂) is the unlock pair: the result of applying [symbol] reversible mask operator to half₂(PW˜) and share-i₁(PW˜).

share-i₂(PW˜):=mask(half₂(PW˜),share-i₁(PW˜))

half₁(r-u1), half₂(r-u1): the result of applying secret sharing(2,2) to r-u1

share-i₁(r-u1) and share-i₂(r-u1) where (i₁,i₂) is the unlock pair: the products of applying secret-sharing(2,2) to half₂(r-u1)

PW˜˜: the bit string representation of a password as provided by the user prior to the initiation of the client-side-state unlock protocol. Note that PW˜˜ and PW˜ are entered at different points in time, possibly by different persons, hence they may be different.

half₂(PW˜˜): the result of applying the password one-way mask operator to PW˜˜ and half₁(PW˜). half₂(PW˜˜):=ow_mask(PW˜˜,half₁(PW˜)). Note that half₂(PW˜˜)=half₂(PW˜) if and only if PW˜˜=PW˜.

share-i₁(PW˜˜) where (i₁,i₂) is the unlock pair: a randomly picked bit string of length L where L is the password mask length

share-i₂(PW˜˜) where (i₁,i₂) is the unlock pair: the result of applying the password reversible mask operator to half₂(PW˜˜) and share-i₁(PW˜˜):

share-i₂(PW˜˜):=mask(half₂(PW˜˜),share-i₁(PW˜˜))

Note that diff(share-i₁(PW˜˜),share-i₁(PW˜)=diff(share-i₂(PW˜˜),share-i₂(PW˜)) if and only if PW˜˜=PW˜.

The ith unlock messenger-token for j in the unlock-pair (i₁,i₂): a unit of data that contains the following elements:

1. the jth server's role (‘master’ or ‘slave’)

2. share-j(PW˜)

3. share-j(r-u1)

4. client-validation-key

5. current value of the success-counter, digitally signed with the client-signature-key

6. identity of the other server in the unlock pair.

7. The jth unlock messenger-token is asymmetrically encrypted with the jth server's public encryption key.

Client-side-state: the following collection of variables and their values:

1. PW˜

2. r-u1

Locked client-side-state: a unit of data that contains the following elements:

1. the unlock pair

2. unlock messenger-tokens for i₁ and i₂

3. half₁(PW˜)

4. half₁(r-u1)

Unlock-retry-counter: a persistent variable at the client-device that counts the number of attempts (carried out by the client) to unlock the current locked client-side-state, that did not result in either success or rejection. The value of the unlock-retry-counter is incremented whenever the client initiates the client-side-state unlock sub-protocol as described below.

The following terms are shown in FIG. 14.

jth unlock-request. for i in the unlock pair: a unit of data that, contains the following elements:

1. jth unlock messenger-token

2. share-j(PW˜˜)

3. current value of the unlock-retry-counter

Slave-request: a unit of data that contains the following elements:

1. jth unlock-request where j is the slave-index.

2. a one-time symmetric encryption key (for encrypting the response)

3. The slave-request is asymmetrically encrypted with the public encryption key of the slave server.

Master-request: a unit of data that contains the following elements:

1. jth unlock-request where j is the master-index.

2. Slave-request

jth unlock-response for j in the unlock pair: a unit of data that contains the following elements:

1. hash(request-j) where request-j is the jth unlock-request

2. one of the following:

a. Decrypted jth unlock messenger-token

b. Rejection indication

Slave-response: a unit of data that contains the following elements:

1. the jth unlock-response where j is the slave-index.

2. The slave-response is encrypted using the symmetric key contained in the corresponding slave-request

Master-response: a unit of data that contains the following elements:

1. the jth unlock-response where j is the master-index

2. slave-response

Balanced PAKE (balanced password authenticated key exchange protocol): an interactive method that allows 2 parties with knowledge of a common password to establish a shared cryptographic key. SPEKE (simple password exponential key exchange) is a known example of a balanced PAKE. SPEKE is described in ACM SIGCO [symbol] Communication Review, vol. 26, no. 5, pp. 5-26

Password verification protocol: an interactive method that allows 2 parties to verify that they know the same password while not allowing any of the parties to learn anything about the other party's password in case that the passwords are different. In a possible embodiment of the password verification protocol, the protocol starts with the execution of a balanced PAKE protocol. The parties then exchange additional messages that allow them to prove to each other that the PAKE protocol resulted in a common key. There are methods (known as ‘key confirmation protocol’) to do this without exposing information about the parties' keys. During the progress of the password verification protocol, each party performs an algorithm that consists of 3 or more steps. The output of each step except the last is sent to the other party. The input of each step includes one or more of the following:

1. The password

2. Values which were picked at random during the progress of the protocol

3. Messages received from the other party and messages sent to the other party during the progress of the protocol

4. Values computed at previous steps

The last step's output is ‘success’ in case that the other party has proved that it knows the password or ‘reject’ otherwise. The password verification protocol is balanced, which means that both parties perform identical algorithms.

Unlock-verification-message: messages exchanged between serve-i₁ and server-i₂ where (i₁,i₂) is the unlock pair, as part of the unlock-verification sub-protocol (described below), have a common structure. The structure allows the recipient of the message to validate it and to relate it to the appropriate context. An unlock-verification-message sent by [symbol] consists of the following elements:

1. Payload (depending on the details of the password verification protocol)

2. The client-validation-key from the jth unlock-request being processed

3. The success-counter from the j th unlock-request being processed

4. The value of the unlock-retry-counter from the jth unlock-request being processed

All exchanged unlock-verification-messages are transmitted authenticated and private as per the above definitions of these terms.

Unlock-abort-timeout: the maximum amount of time that can elapse between beginning the unlock-protocol until the protocol completes or aborts. The unlock-abort-timeout is determined by configuration settings at the client device.

Unlock-retry-timeout: the amount of time that a client waits since sending a master-request until receiving the corresponding mater-response and before restarting the protocol. The unlock-restart-timeout is determined by configuration settings at the client device.

jth client-side-state unlock-state for i in the unlock pair: a data structure that is added to every entry of the server-side state-repository. The jth unlock-state supports the unlock-verification sub-protocol as described below. It contains the following variables:

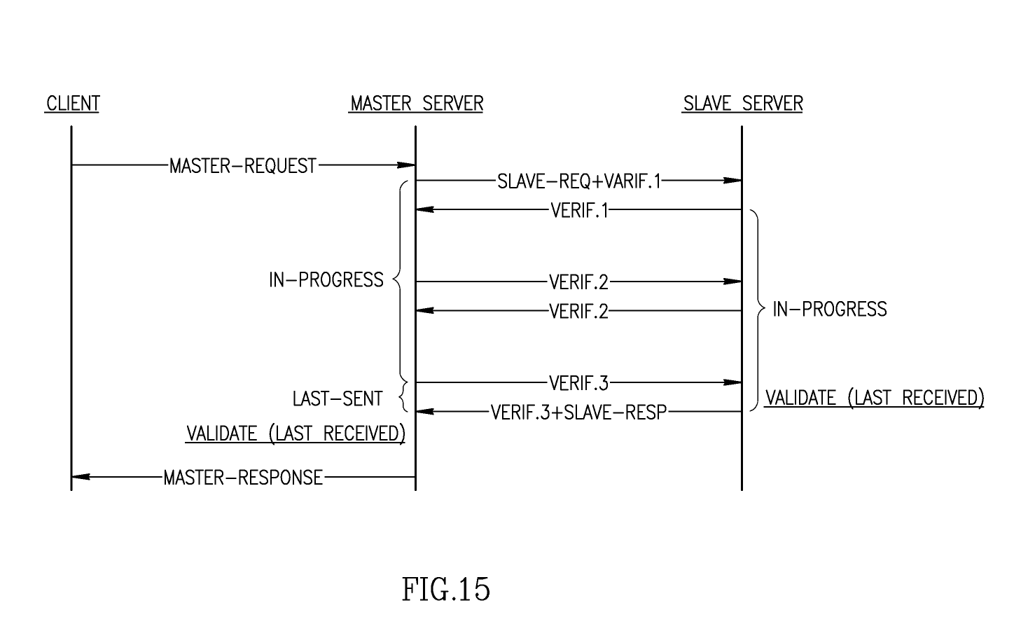

1. Unlock-verification-status: As shown in FIG. 15, this variable has 5 possible values:

a. Initial

b. In-progress

c. Last-sent (indicates that the last outbound unlock-verification-message has been sent)

d. Success

e. Reject

2. Processed unlock-request: the jth unlock-request which is being p [symbol] moment.

3. The one-time symmetric key from the slave-request which is being processed at the moment (applicable only to the slave-server).

4. unlock-retry-counter (initial value is 0)

5. Collection of variables which hold values that were computed or picked at random by the jth server during the progress of the unlock-verification sub-protocol.

6. Collection of inbound messages (sent by the other server of the unlock pair) that were received during the progress of the unlock-verification sub-protocol

7. Collection of outbound messages that were sent to the other server of the unlock pair during the progress of the unlock-verification sub-protocol.

The terms “client-side-state unlock-state” and “unlock-state” are used interchangeably hereinafter.

Adjustment to the definition of the server-side-state repository:

In order to support client-side-state lock/unlock, each entry in the server-side-state repository of the jth server will contain, in addition to the elements listed above, a client-side-state unlock-state as defined above. All variables of the client-side-state unlock-state are persistent.

### Adjustment to the Secret Concealment Process

In order to support the client-side-state protection method, the following adjustment is made to the secret concealment process defined above:

Whenever the client increments the success-counter, it also creates a digital signature on the new value using the client-signature-key and stores the signature locally at the device. Note that the client-signature-key is MPSP encrypted, so that the MainKey is re [symbol] to access it. Hence the signature cannot be forged by attackers who obtain the client device.

As mentioned above, the signed success-counter is included in every unlock messenger-token.

### Client-Side-State Lock Process

The purpose of the client-side-state lock process is to preserve the client-side-state during the progress of the secret reconstruction process so that the state can be reconstructed later in case the secret reconstruction process cannot be completed due to network connection problems. FIG. 13, to which reference is now made, depicts the client-side-state lock process. The input to this protocol consists of the client-side-state (as defined above). The protocol is carried out by the client-device without involvement of any other machine. The result of the protocol is the locked-client- side-state (as defined above) which is then stored locally on the device. The protocol proceeds as follows:

1. Client: picks the unlock pair (i₁,i₂) at random where i₁ and i₂ are in {1 . . . n}. Server-i₁ is the master-server and server-i₂ is the slave-server.

2. Client: creates half₁(PW˜), half₂(PW˜), share-i₁(PW˜), share-i₂(PW˜) as described above.

3. Client: creates the jth unlock messenger-token for j in {1₁,i₂}

4. Client: creates the locked client-side-state and stores it locally.

### Unlock-Verification Step-Advancement Sub-Protocol:

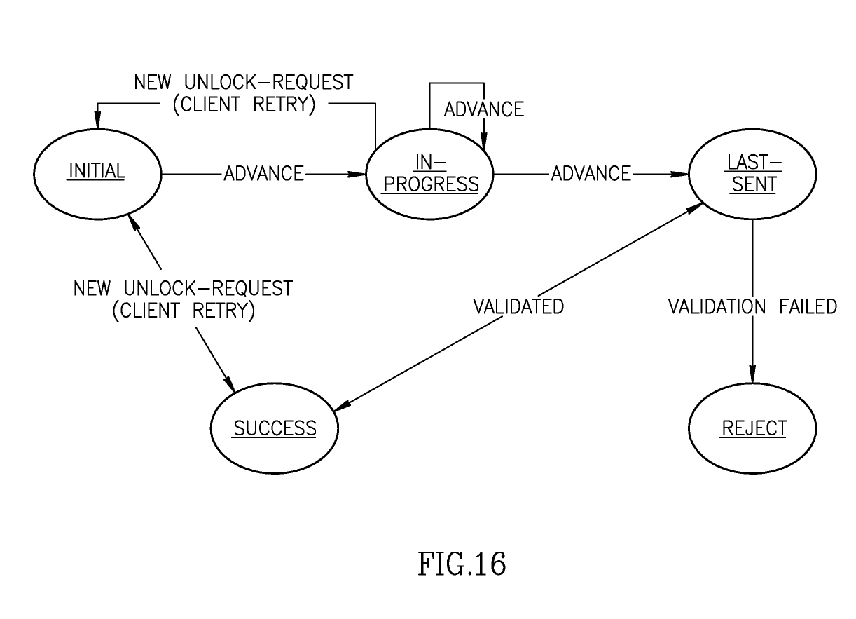

This sub-protocol is carried out by each server-j where j is in the unlock pair, at certain points in the unlock-verification sub-protocol (described below with respect to FIG. 16). The purpose of this sub-protocol is to perform the next step in the interaction between the servers. The input to the unlock-verification step-advancement sub-protocol is the jth unlock-state as defined above. Variable names mentioned in this section refer to members of th [symbol] The discussion below describes how this sub-protocol moves from one state to the next in the state machine shown in FIG. 15. For server-j, where j is in {i₁, i₂}, the protocol proceeds as follows:

1. server-j: if the value of the unlock-verification-status is ‘success’ or ‘reject’, then stops (does nothing and returns).

2. server-j: if the unlock-verification-status is ‘initial’ then:

a. extracts the value share-j(PW˜˜) from the processed unlock-request and the value share-j(PW˜) from the contained jth unlock messenger-token.

b. computes the value checkpw-j=diff(share-j(PW˜˜),share-j(PW˜)) where cliff is the difference operator as defined above.

c. stores checkpw-j as a variable in the unlock-state

d. sets the unlock-verification-status in the unlock-state to ‘in-progress’

3. server-j: if the unlock-verification-status is ‘in-progress’ then:

a. follows the password verification protocol (as defined above) to compute the next outbound message that will be sent to the other server in the pair. The required input for this step (including previously sent and received messages) is taken from the unlock-state and the value of checkpw-j is taken as the password input for the password verification protocol. During this step server-j may pick values at random and/or compute new values as dictated by the password verification protocol. Such values are stored as variables in the unlock-state.

b. extracts the client-validation-key, the success-counter, and the unlock-retry-counter from the processed unlock-request and creates a new unlock-verification-message (as defined above) with these values and with the message produced in the previous step as the payload.

c. stores the produced unlock-verification-message in the unlock-state [symbol] the server in the pair over the network. The identity of the other server in the pair is taken from the jth unlock messenger-token. The message is transmitted privately and authenticated.

d. if the sent message is the final outbound message of the password verification protocol then the unlock-verification-status is set to ‘last-sent’.

4. server-j: if the unlock-verification-status is ‘last-sent’ and the unlock-state contains the final inbound message from the other server in the pair then follows the password verification protocol (as defined above) to compute the final result (‘success’ or ‘reject’) and sets the unlock-verification-status accordingly.

### Unlock-Verification Sub-Protocol

This sub-protocol defines the parts of the master-server and slave-server in the client-side-state unlock sub-protocol. FIG. 15 depicts the outline of the unlock-verification sub-protocol. The unlock-verification sub-protocol consists of 3 algorithms as follows:

1. Reaction to incoming master-request: this algorithm is performed by the server-i₁ (the master-server) where (i₁,i₂) is the unlock pair upon receipt of a new master-request sent by a client:

A. Master-server: decrypts the unlock messenger-token contained in the master-request, extracts the client-validation-key and the signed success-counter from the contained messenger-token and validates the success-counter's signature. If validation of the signature fails then stops the processing of the request.

B. Master-server: verifies that the role in the messenger-token is ‘master’. Otherwise, stops the processing of the request.

C. Master-server: uses the client-validation-key from the received messenger-token to lookup the server-side-state in the local state-repository. If no matching entry is found in the repository, then it creates a new entry for the client and populates the entry wi [symbol] counter value from the unlock-messenger-token.

D. Master-server: compares the success-counter value in the received messenger-token with the value in the server-side-state repository.

i. If the first is smaller than the latter then stops the processing of the request.

ii. If the first is bigger than the latter then resets the content of the repository's entry (all values are set to default) and updates the success-counter value in the repository to the new value.

E. Master-server: extracts the unlock-state from the client's entry in the repository and checks the value of the contained unlock-verification-status.

F. Master-server: If the unlock-verification-status is ‘initial’ or ‘in-progress’ or ‘success’ then extracts the value of the unlock-retry-counter from the received request message and compares it to the unlock-retry-counter value in the unlock-state:

i. If the first is smaller than or equal to the latter then stops the processing of the request.

ii. If the first is bigger than the latter then:

a. clears the variables in the unlock-state and sets the unlock-verification-status to ‘initial’.

b. updates the unlock-retry-counter in the unlock_state to the new value

c. extracts the itth unlock-request from the master-request and assigns it to the processed unlock-request in the unlock-state,

d. extracts the slave-request from the master-request and sends it to the slave-server. The identity of the slave-server is taken from the messenger-token.

e. performs the unlock-verification step-advancement sub-protocol as [symbol] Comment: this step and the previous step both send messages to the slave-server. In order to ensure that the second message does not arrive before the first, the 2 messages are combined into one message.

G. Master-sen-er: If the unlock-verification-status is ‘reject’ then

i. creates the iith unlock-response with rejection-indication.

ii. creates a master-response that contains the ijth unlock-response (and no slave-response) and sends it to the client. The message is transmitted privately and authenticated.

H. Master-server: if the unlock-verification-status is ‘last-sent’ then:

i. extracts the final-outbound-message from the unlock-state and re-scads it to the slave-server.

ii. discards the received master-request.

Note: discarding the master-request at this point ensures that the slave-server won't be able to participate in an online dictionary attack on the user's password. Consider an attempt by an attacker who controls the client-device and the slave-server, to learn incorrect passwords by repeatedly triggering the unlock protocol with different passwords. The fact that the master-server discards new master-requests while in ‘last-sent’ state ensures that the attacker will not be able to learn more than one incorrect password before the master-server moves into ‘reject’ state.

2. Reaction to incoming slave-request: this algorithm is performed by the server-i₂ (slave-server) where (i₁,i₂) is the unlock pair, upon receipt of a new salve-request sent by the master-server:

A. Slave-server: decrypts the slave-request and the contained unlock messenger-token, extracts the client-validation-key and the signed success-counter from the messenger-token and validates the signature on the success-counter. If validation of the signature fails [symbol] processing of the request.

B. Slave-server: verifies that the role in the messenger-token is ‘slave’. Otherwise, stops the processing of the request.

C. Slave-server: uses the client-validation-key from the received messenger-token to lookup the server-side-state in the local server-side-state repository. If no matching entry is found in the repository then creates a new entry for the client and populates it with the success-counter value from the unlock-messenger-token.

D. Slave-server: compares the success-counter value in the received messenger-token with the value in the server-side-state repository.

i. If the first is smaller than the latter then stops the processing of the request.

ii. If the first is bigger than the latter then resets the content of the repository's entry (all values are set to default) and updates the success-counter value in the repository to the new value.

E. Slave-server: extracts the unlock-state from the client's entry in the repository and checks the value of the contained unlock-verification-status.

F. Slave-server: if the unlock-verification-status is ‘reject’ or ‘last-sent’ then stops the processing of the request. Note that in reality we will not reach this point while the status is ‘last-sent’ because the slave-server never waits in this state.

G. Slave-server: extracts the value of the unlock-retry-counter from the received slave-request and compares it to the unlock-retry-counter value in the unlock-state:

i. If the first is smaller than or equal to the latter then stops the processing of the request.

ii. If the first is bigger than the latter then:

a. clears the variables in the unlock-state and sets the unlock-verific [symbol] ‘initial’.

b. updates the unlock-retry-counter in the unlock_state to the new value

c. extracts the i₂th unlock-request and the one-time symmetric-key from the slave-request and stores them in the unlock-state.

d. at this point the slave-server expects to receive the initial inbound unlock-verification-message from the master-server. Note that the slave-server does not perform the unlock-verification step-advancement sub-protocol until that message is received, thereby ensuring that any unlock-verification-message from the slave-server to the master-server is sent in response to a message from the master-server to the slave-server.

3. Reaction to incoming unlock-verification-message: this algorithm is performed by each server-j in the unlock pair, upon receipt of a new unlock-verification-message sent by the other server in the pair. Note that all unlock-verification-messages are sent authenticated and private:

A. Server-j: uses the client-validation-key from the received message to lookup the client's server-side-state in the local server-side-state repository. If no matching entry is found in the repository then stops the processing of the message.

B. Server-j: compares the success-counter value in the received message with the value found in the server-side-state repository. If the values are different then stops the processing of the message.

C. Server-j: extracts the processed unlock-request from the unlock-state in the repository, extracts the contained jth unlock messenger-token, extracts the identity of the other server in the pair from the messenger-token and verifies that it matches the sender of the received message. If there is no match then stops the processing of the message.

D. Server-j: extracts the value of the retry-counter from the receive [symbol] compares it to the value contained in the unlock-state in the client's entry of the repository. If the values are different then stops the processing of the message.

E. Server-j: extracts the unlock-messenger-token for the jth processed unlock-request and checks the value of the role, if the role is ‘slave’ and the current unlock-status is ‘last-sent’ and the received message is identical to the last inbound unlock-verification-message (replayed message) then:

i. resends the last sent outbound unlock-verification-message to the other server in the pair (the master-server).

ii. stops the processing of the received message.

F. Server-j: if the payload of the received message does not match the expected input at the current step of the password-verification protocol then stops the processing of the message.

G. Server-j: stores the received message in the unlock-state.

H. Server-j: performs the unlock-verification step-advancement sub-protocol as described above.

I. Server-j: checks the value of the unlock-verification-status in the unlock-state,

i. if the value is ‘in-progress’ or ‘last-sent’ then does nothing and stops.

ii. if the value is ‘reject’ then creates the jth unlock-response with rejection-indication and proceeds to the next step.

iii. if the value is ‘success’ then extracts the (decrypted) jth unlock-messenger-token from the processed unlock-request, creates the jth unlock-response and proceeds to the next step.

J. Server-j: checks the role in the processed jth unlock-messenger-token.

i. if the role is ‘slave’ then creates a slave-response based on the previo [symbol] unlock-response and sends it to the master-server. Note that the slave-response is always sent immediately after the last outbound unlock-verification-message. In order to ensure that the 2 messages arrive in the correct order, the slave-response is not sent as an independent message but rather added to the payload of the last unlock-verification-message sent to the master-server.

ii. if the role is ‘master’ then: extracts the slave-response from the received unlock-verification-message, creates a master-response with the received slave-response and the previously created jth unlock-response, and sends it to the client. The master-response is transmitted privately and authenticated.

### Client-Side-State Unlock Sub-Protocol

The purpose of the client-side-state unlock sub-protocol (also referred to as the unlock sub-protocol) is to reconstruct the latest client-side-state in case the last secret reconstruction attempt could not be completed due to network connection problems. In such event, the latest client-side-state is preserved securely in the form of the locked client-side-state as described above. On the next secret reconstruction attempt, the client-side-state is first reconstructed from the locked-client-side-state via the unlock sub-protocol. The unlock sub-protocol is initiated by the client and involves server-j where j is in the unlock pair. FIG. 14 depicts steps 1 through 5 of the client-side-state unlock sub-protocol. FIG. 15 depicts the outline of the client-side-state unlock sub-protocol. Assuming that the servers are accessible, the unlock sub-protocol will succeed if and only if the password provided by the user is identical to the password entered during the aborted secret reconstruction attempt. The output of the unlock sub-protocol is one of the following:

1. r-u1

2. rejection indication

3. timeout indication

The protocol proceeds as follows:

1. Client: increments the unlock-retry-counter

2. Client: given the locked-client-side-state (as previously generated via the client-side-state lock process) and a user provided password PW , generates the jth unlock-request for each j in the unlock pair. The unlock requests are kept in memory until the end of the unlock sub-protocol.

3. Client: creates the slave-request and keeps the contained one-time symmetric encryption in memory.

4. Client: creates the master-request based on the previously computed values and sends it to the master server privately.

5. The master-server and slave-server perform their parts according to the unlock-verification sub-protocol as described above.

6. Client: waits to receive the master-response from the master-server. Note that all messages from a server to a client are sent privately and authenticated.

7. Client: decrypts the slave-response contained in the master-response (if it exists), extracts the jth unlock-response for each j in the unlock pair and performs validation as follows: computes hash(request-j) where request-j is the last sent jth unlock-request, extracts hash(request-j) from the jth unlock-response and verifies that the values are identical. If this validation fails then discards the received response.

8. Client: if fails to receive a valid master-response within the unlock-abort-timeout, deletes the unlock-requests from memory, outputs timeout indication and stops.

9. Client: if fails to receive a valid master-response within the unlocl [symbol] since sending the last master-request, deletes the unlock-requests from memory and returns to step i

10. Client: if any of the extracted unloclt-responses contains rejection indication then outputs rejection indication and stops.

11. Client: performs validation as follows:

a. retrieves share-i₁(PW˜) and share-i₂(PW˜) from the decrypted unlock messenger-tokens, computes unmask(share-i₂(PW˜),share-i₁(PW˜)) and verifies that the result is identical to half₂(PW˜˜).

b. asymmetrically encrypts the contained jth messenger-token with the public encryption key of the jth server for each j in the unlock pair and verifies that the result is identical to the locally stored jth unlock messenger-token.

If the above validation fails (this indicates that at least one server is corrupted), then the client outputs the rejection indication and stops.

12. Client: extracts share-i₁(r-u1) and share-i₂(r-u1) from the decrypted unlock messenger-tokens and reconstructs half₂(r-u1) from them, then reconstructs r-u1 from half₁(r-u1) and half₂(r-u1) and outputs the result.

### Adjustments to the Definition of the Client Secret Reconstruction Sub-Protocol:

The following steps are added to the client secret reconstruction sub-protocol (described above). These steps are performed instead of step 5:

1. Client: if the value of r-u1 is already defined then does nothing (skips the steps below).

2. Client: if a locked client-side-state exists at the device, initiates the c

[symbol]

unlock sub-protocol as described above. If the client-side-state unlock sub-protocol cannot be completed due to connection problems then outputs error indication and stops.

3. Client: If the client-side-state unlock sub-protocol completes successfully then the client now has the last value of r-u1, which is used for the rest of the protocol.

4. Client: if the client-side-state unlock sub-protocol fails (request rejected by server) then the locked client-side-state is deleted and ignored and the processing proceeds as if no locked client-side-state existed.

5. Client: if no locked client-side-state exists then picks a new value for r-u1 at random.

6. Client: if no locked client-side-slate exists then applies the client-side-state lock process to PW˜ and r-u1, and stores the new locked-client-side-state locally.

Following the above steps, the protocol proceeds exactly as specified in the definition of the client secret reconstruction sub-protocol above. If the secret reconstruction process completes (i.e. is not aborted due to connection problems) then the client deletes the latest locked client-side-state from its memory.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for [symbol] operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A secret protection method operative on a user's device with a group of servers, the method comprising:
concealing a secret on said user's device with the user's password, said concealing not involving any of said servers;
storing the output of said concealing on said device; and
reconstructing said secret from a newly received password and said stored output in conjunction with a subset of said group of servers, wherein said reconstructing is minimally affected by intermittent network connection problems and attacks that interfere with the communication between said user's device and said subset of servers.
wherein said reconstructing comprises:
performing an enhanced PPSS (Password Protected Secret Sharing) reconstruction protocol between said user's device and said subset of servers; and
receiving the results of throttling performed by each of said subset of servers.

2. The method according to claim 1 and wherein said concealing comprises implementing a PPSS-Init process and encrypting asymmetrically PPSS private states produced by said PPSS-Init process with public keys of said servers.

3. The method according to claim 2 and wherein said concealing comprises generating a plurality of messenger tokens, one per server, each said messenger token comprising at least: one of said encrypted PPSS private states and throttling data, wherein [symbol] comprises signing at least part of each said messenger token with a client signature key.

4. The method according to claim 3 and wherein said reconstructing comprises transmitting messages between said user's device and said subset of servers, each said message comprising at least one of: a messenger token and a PPSS message.

5. The method according to claim 4 and wherein said throttling data comprises a proof of success, if the secret was successfully reconstructed since the last time reconstruction occurred, and wherein said messages comprise a proof of same password, if the same password was used said last time.

6. The method according to claim 5 and wherein said proof of success is embodied in a success counter and a valid client signature.

7. The method according to claim 5 and wherein said throttling comprises each said server of said subset of servers checking for said proof of success and proof of repeated password and generating a foul event when neither proof is received, generating a success event when said proof of success is received and not generating a new foul event if said proof of repeated password is received from said device.

8. The method according to claim 7 and wherein said throttling comprises determining whether to reject or accept a message from a device as a result of said checking and the recent history of said foul and success events.

9. The method according to claim 1 and wherein said concealing comprises preserving a last client-side state on said device in a secure manner and wherein said reconstructing comprises recovering said last client-side state with a pair of said group of servers when said reconstructing follows a previously aborted reconstruction attempt, and wherein said recovering will succeed only if the user has entered again exactly the same [symbol] said aborted attempt.

10. The method according to claim 5 and also comprising after a successful reconstruction, generating said proof of success by incrementing a success counter, generating new said messenger tokens at least with said success counter and at least partially signing said messenger tokens with a client signature key.

11. The method according to claim 10 and comprising each said server of said subset of servers verifying said signature with a client-validation-key associated with said client signature key.

12. The method according to claim 11 and also comprising each said server of said subset of servers verifying that a received said success counter is greater or equal to a stored said success counter, stored on each said server, and updating said stored success counter if the output of said verifying is positive.

13. A secret reconstruction process operative on a server, the process comprising:
receiving a message from a user's device, said message comprising at least one of: a PPSS message, an encrypted PPSS private state, a proof of success, if the secret was successfully reconstructed since the last time reconstruction involving said server occurred, and a proof of same password, if the same password was used said last time;
checking at least said proof of success and proof of same password against a stored client state for said user's device to determine if said reconstruction can proceed;
updating said stored client state; and
if the output of said checking is positive, performing a [symbol] reconstruction operation on said PPSS private state and/or PPSS message within said message.

14. The process according to claim 13 and wherein said client state comprises at least a client validation key and a success counter.

15. The process according to claim 14 and wherein said checking comprises verifying a signature of said message with said stored client-validation-key.

16. The process according to claim 13 and wherein said checking comprises checking for said proof of success and proof of repeated password and generating a foul event when neither proof is received, generating a success event when said proof of success is received and not generating a new foul event if said proof of repeated password is received from said device.

17. The process according to claim 14 and wherein said checking comprises checking that said success counter is greater than or equal to said stored success counter, and updating said stored success counter if the output of said verifying is positive

18. The process according to claim 13 and also comprising receiving a message from a user's device to perform an unlock process and unlocking a locked client-side-state together with one other server.

19. A secret protection unit for a user's device operative with a group of servers, the unit comprising:
a secret concealment unit to conceal a secret on said user's device with the user's password, said secret concealment unit not operating with any of said servers;
a storage unit to store the output of said secret concealment unit; and
a secret reconstruction unit to reconstruct said secret from a n [symbol] password and said stored output in conjunction with a subset of said group of servers, wherein said secret reconstruction unit is minimally affected by intermittent network connection problems and attacks that interfere with the communication between said user's device and said subset of servers,
wherein said secret reconstruction unit comprises:
an enhanced PPSS unit to perform an enhanced PPSS (Password Protected Secret Sharing) reconstruction protocol between said user's device and said subset of servers; and
a throttling receiver to receive the output from throttling units on each of said subset of servers.

20. The unit according to claim 19 and wherein said secret concealment unit comprises a PPSS-Init process to implement a PPSS-Init process and an encrypter to asymmetrically encrypt PPSS private states produced by said PPSS-Init process with public keys of said servers.

21. The unit according to claim 20 and wherein said secret concealment unit comprises a token generator to generate a plurality of messenger tokens, one per server, each said messenger token comprising at least: one of said encrypted PPSS private states and throttling data, wherein said token generator comprises a digital signer to sign at least part of each said messenger token with a client signature key.

22. The unit according to claim 21 and wherein said secret reconstruction unit comprises a transmitter to transmit messages between said user's device and said subset of servers, each said message comprising at least one of: a messenger token and a PPSS message.

23. The unit according to claim 22 and wherein said throttling data compri [symbol] success, if the secret was successfully reconstructed since the last time reconstruction occurred, and wherein said messages comprise a proof of same password, if the same password was used said last time.

24. The unit according to claim 23 and wherein said proof of success is embodied in a success counter and a valid client signature.

25. The unit according to claim 23 and wherein said throttling unit on each said server of said subset of servers comprise checkers to check for said proof of success and proof of repeated password and to generate a foul event when neither proof is received, to generate a success event when said proof of success is received and not to generate a new foul event if said proof of repealed password is received from said device.

26. The unit according to claim 25 and wherein each said throttling unit comprises a determiner to determine whether to reject or accept a message from a device as a result of said checking and the recent history of said foul and success events.

27. The unit according to claim 19 wherein said secret concealment unit comprises a locking unit to preserve a last client-side state on said device in a secure manner and wherein said secret reconstruction unit comprises a locked state recoverer to recover said last, client-side state, with a pair of said group of servers after a previously aborted reconstruction attempt, and wherein said secret reconstruction unit, will succeed only if the user has entered again exactly the same password as in said aborted attempt.

28. The unit according to claim 23 and wherein said secret reconstruction unit also comprises a generator to generate said proof of success after a successful reconstruction by incrementing a success counter, to generate new said messenger tokens at least with said success counter and to at least partially sign said messenger tokens with a client signature key.

29. The unit according to claim 28 and wherein each said server of said su [symbol] comprises a verifier to verify said signature with a client-validation-key associated with said client signature key.

30. The unit according to claim 29 and said verifier also comprises a second verifier to verify that a received said success counter is greater or equal to a stored said success counter, stored on each said server, and to update said stored success counter if the output of said verifying is positive.

31. A secret reconstruction unit on a server, the unit comprising:
a receiver to receive a message from a user's device, said message comprising at least one of: a PPSS message, an encrypted PPSS private state, a proof of success, if the secret was successfully reconstructed since the last time reconstruction involving said server occurred, and a proof of same password, if the same password was used said last time;
a checker to check at least said proof of success and proof of same password against a stored client state for said user's device to determine if said reconstruction can proceed;
an updater to update said stored client state; and
a reconstructer to perform a portion of a reconstruction operation on said PPSS private state and/or PPSS message within said message, if the output of said checking is positive.

32. The unit according to claim 31 and wherein said client state comprises at least a client validation key and a success counter.

33. The unit according to claim 32 and wherein said checker comprises a veri [symbol] signature of said message with said stored client-validation-key.

34. The unit according to claim 31 and wherein said checker comprises a second checker to check for said proof of success and proof of repeated password and to generate a foul event when neither proof is received, to generate a success event when said proof of success is received and to not generate a new foul event if said proof of repeated password is received from said device.

35. The unit according to claim 32 and wherein said checker comprises a second checker to check that said success counter is greater than or equal to said stored success counter, and to update said stored success counter if the output of said verifier is positive

36. The unit according to claim 31 and wherein said receiver comprises a second receiver to receive a message from a user's device to perforin an unlock process and said reconstructer comprises an unlocker to unlock a locked client-side-state together with one other server.
